(19) United States
(12) Patent Application Publication
(10) Pub. No.: US 2011/0252112 A1
(43) Pub. Date: Oct. 13, 2011

(54) SYSTEM AND METHOD FOR COMMUNICATING WITH ELECTED OFFICIALS

(75) Inventor: Richard H. Glanton, Princeton, NJ (US)

(73) Assignee: Richard H. Glanton, Princeton, NJ (US)

(21) Appl. No.: 13/077,232

(22) Filed: Mar. 31, 2011

Related U.S. Application Data
(63) Continuation-in-part of application No. 13/009,642, filed on Jan. 19, 2011.
(60) Provisional application No. 61/296,070, filed on Jan. 19, 2010.
(60) Provisional application No. 61/354,870, filed on Jun. 15, 2010.

(51) Int. Cl. G06F 15/16

(52) U.S. Cl. 709/217

(57) ABSTRACT

A system and method for communicating with elected officials and/or candidate for office is provided. One method comprises: storing, at a server operatively connected to a communication network, information associated with at least one official, wherein the information defines a constituency group for each elected official and for each candidate for election for which information is stored on the server; qualifying a user for one or more of the constituency groups when the user accesses the server through a computing device, the qualifying comprising determining which of the at least one official represents the user based on a voting based geographic parameter of the user; and providing the user access through a common portal to information associated with the at least one official for which the user is a qualified member of the respective constituency group.

### PRIORITY

The instant application claims priority to and is a continuation-in-part of U.S. patent application Ser. No. 13/009642 filed Jan. 19, 2011, which itself claims priority U.S.C. §119 to U.S. patent application Ser. No. 61/296,070 filed Jan. 19, 2010; and U.S. patent application Ser. No. 61/354,870 filed Jun. 15, 2010, all entitled “SYSTEM AND METHOD FOR COMMUNICATING WITH ELECTED OFFICIALS”. The disclosures of the aforementioned priority documents are incorporated herein by reference in their entireties.

### FIELD OF THE INVENTION

The invention generally relates to an information service for providing information about elected officials.

### SUMMARY OF THE INVENTION

Certain embodiments of the invention provide for a system and method for communicating with and/or about elected officials by providing information regarding elected officials, such as information that falls within the purview of elected officials' responsibility and duties and information related to their offices and service in such offices.

Certain embodiments of the invention relate to establishing a comprehensive mode of facilitating online communications to, from, about, between, or among Internet users/members concerning “elected officials” and/or candidates for election via a website, such as a website that can be referred to as Elected Face, by way of non-limiting example. Elected Face may enable online users/members who reside in the political areas where elected officials serve, to post comments concerning political matters on pages applicable to affected elected officials via the website. Elected officials may elect to monitor such postings and opt to respond or do nothing. Online users/members may comment concerning postings which appear on any page of the website of Elected Face. Postings on pages of elected officials may appear as local or national postings as described below. According to certain embodiments of the invention, Elected Face members/online Internet users who live outside the political entity or district of the affected elected official may be enabled to post comments on the page of the elected official only in space provided for national postings. According to certain embodiments of the invention, only online Internet users/members who reside in the political entity represented by elected officials may be enabled to post comments on the local pages of the affected local official.

According to certain embodiments of the invention, Elected Face members/online users may communicate with affected elected officials as noted above via text, photo, video and/or audio communications, such as to post videos relating to elected officials on their pages on the website of Elected Face.

The pages of elected officials may contain basic biographical information including employment history, religious and political affiliations, and/or any other available information concerning elected officials and/or their special interests.

According to certain embodiments of the invention, the name of office held, term of years and certain political information concerning the status of the elected official may be provided on the page of each elected official identified on the website, with a stream of updates, for example.

According to an embodiment of the invention, a method for communicating with elected officials and/or candidates for office includes: storing, at a server operatively connected to a communication network, information associated with at least one official, wherein the information defines a constituency group for each elected official and for each candidate for election for which information is stored on the server; qualifying a user for one or more of the constituency groups when the user accesses the server through a computing device, the qualifying comprising determining which of the at least one official represents the user based on a voting based geographic parameter of the user; and providing the user access through a common portal to information associated with the at least one official for which the user is a qualified member of the respective constituency group.

### BRIEF DESCRIPTION OF THE FIGURES

Understanding of the invention will be facilitated by consideration of the following detailed description of the preferred embodiments of the invention taken in conjunction with the accompanying drawings, in which like numerals refer to like parts, and in which:

FIG. 1 illustrates a block diagrammatic representation of a system according to an embodiment of the invention.

FIG. 2 illustrates a browser embodiment of the invention; and,

FIGS. 3-20 illustrate graphical user interfaces according to embodiments of the invention.

FIGS. 21-45 illustrate graphical user interfaces according to embodiments of the invention that may include group utilization options.

### DETAILED DESCRIPTION OF THE PREFERRED EMBODIMENTS OF THE INVENTION

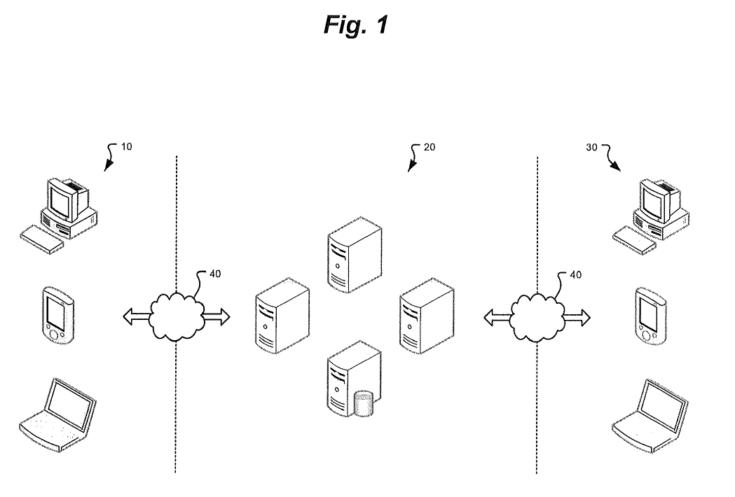

Referring now to FIG. 1, there is shown a configuration of a system according to an embodiment of the invention. In certain embodiments of the invention, such a system is well suited for performing and/or providing functionalities described herein.

In the illustrated embodiment, the system generally includes a first class of computing devices 10, a second class of computing devices 20 and a third class of computing devices 30. In certain embodiments of the invention, the groups need not be mutually exclusive. For example, one or more certain computing devices may be members of more that one of classes 10, 20 and/or 30. Generally, each of the computing devices of classes 10, 20 and 30 are communicatively interconnected with one another via at least one network, such as the Internet and/or wire line and wireless communications networks. In the illustrated embodiment of FIG. 1, the computing devices of classes 10, 30 are interconnected with the computing devices of class 20 via network connections 40. In certain embodiments of the invention, one or more of the computing device interconnections, such as connections 40 by way of non-limiting example, may take the form of Internet or other data network connections.

In certain embodiments of the invention, class 10 and 30 computing devices may generally take the form of end-user computing devices, such as personal computers, terminals, Internet enabled appliances or video game consoles, such as the Sony PlayStation3, personal digital assistants and/or cellular telephones or smart phones, for example.

In certain embodiments of the invention, class 20 computing devices may generally take the form of servers, for example. In certain embodiments of the invention, class 20 computing devices may correspond to network or system servers, such as website and/or database servers, for example.

In certain embodiments of the invention, computing devices in class 20 provide a website that is accessible by computing devices in classes 10, 30, for example. By way of non-limiting example, providing such a website may generally include providing database services, and providing populated website pages using the database services.

By way of non-limiting explanation, “computing device”, as used herein, refers to a general purpose computing device that includes a processor, such as a device that possesses general purpose computing capabilities. A processor generally includes a Central Processing Unit (CPU), such as a microprocessor. A CPU generally includes an arithmetic logic unit (ALU), which performs arithmetic and logical operations, and a control unit, which extracts instructions (e.g., code) from a computer readable medium, such as a memory, and decodes and executes them, calling on the ALU when necessary. “Memory”, as used herein, generally refers to one or more devices or media capable of storing data, such as in the form of chips or drives. For example, memory may take the form of one or more random-access memory (RAM), read-only memory (ROM), programmable read-only memory (PROM), erasable programmable read-only memory (EPROM), or electrically erasable programmable read-only memory (EEPROM) chips, by way of further non-limiting example only. Memory may be internal or external to an integrated unit including the processor. Memory may take the form of magnetic or optical-technology based storage media. Memory may be internal or external to a computing device. Memory may store a computer program, e.g., code or a sequence of instructions being operable by the processor. In certain embodiments of the invention, one or more elements may take the form, or functionalities discussed may be provided using code being executed using one or more computing devices, such as in the form of computer device executable programs or applications being stored in memory. There are various types of computing devices, having varying processing and memory capabilities, such as: personal computers (like those that are commercially available from Dell and Apple Corp.), and personal digital assistants and smart phones (like those that are commercially available from Apple Corp., Motorola and Research in Motion), by way of non-limiting example only.

A “server”, as used herein, is generally communicatively coupled to a network, and manages network resources. A server may refer to a discrete computing device, or may refer to an application that is managing resources rather than an entire computing device. “Network”, as used herein, generally refers to a group of two or more computing devices communicatively connected to one-another. “Internet”, as used herein, generally refers to the global interconnection of computing devices, and computing device networks, commonly referred to as such.

“Website”, as used herein, generally refers to a collection of one or more electronic documents (e.g., webpages) that are available via a computer network, such as the global interconnection of computers and computer networks commonly referred to as the Internet. By way of non-limiting example, a website may be accessed at a given address on the World Wide Web (i.e., “www.URL.TLD”), and include a home page, which is the first webpage visitors typically see when they enter the site. A website may also contain additional webpages. Webpages may be fixed, and/or dynamically generated in response to website visitor webpage requests. By way of further non-limiting example only, the World Wide Web is a system of Internet servers that support HTML (Hypertext Markup Language), such that a website visitor can jump from one webpage to another webpage simply by clicking on references to other webpages, such as hot spots or hot links (sometimes referred to as “links”). Web browsing applications, such as Microsoft's Internet Explorer, Google's Chrome, and Apple's Safari, or application specific portals, can be used to access websites on the World Wide Web. Other computer network types and/or protocols and/or mark up languages and/or applications may be used. Webpages are typically served by servers.

In certain embodiments of the invention, the system may include or provide a website to host information about elected officials and/or candidates for election. This information may include but is not limited to names, date of birth, education and professional background, and offices held in the United States and/or other countries. The website may be substantially continually updated, such as by having information change as offices held by office holders' change. Such a functionality may be provided automatically, such as based upon automated queries or other accessing of public filings. Other methodologies may be used though, such as manual methods. The website may include functionality enabling citizens of an affected country, who becomes a member of the website, to post communications on political issues on the page(s) of the website corresponding to their elected officials with whom the citizen wishes to communicate with or about, for example.

In certain embodiments of the invention, an online user may wish to access an embodiment of an inventive home web page through the website on the World Wide Web. A tool bar may list functions and categories under an appropriate heading which prompts users to access functions to be utilized. By way of non-limiting example, a heading may include a home page which designates an identifier and/or IP address of a system member or online user. A pop-up bar may appear which provides a list of options of elected officials on whose page a member or online user or others may post comments, starting with elected officials at local, state, and/or national levels.

According to certain embodiments of the invention, members and/or users may have an option to post comments on a page corresponding to an elected official of their choice. A toolbar may enable members and/or online users to navigate to the page of any or every elected official, such as in the United States, to whom they wish to address comments to be posted. A toolbar may enable members and/or online users to navigate to the page of any or every elected official, such as in the United States, to whom they correspond, e.g., have a constituency. The tool bar may contain other sections. By way of non-limiting example, the toolbar may include a “favorites” section which may correspond to a primary listing of elected officials the user and/or member regularly communicates with through postings. By way of further non-limiting example, the toolbar may include a section comprising biographies of members and/or users comprising their respective background information. By way of further non-limiting example, the toolbar may include a section comprising an inbox for members or users to communicated directly with an elected official without posting for public access.

In certain embodiments of the invention, postings and/or petitions and/or virtual petition signatures from constituents of a given elected official may be distinguishable from postings and/or petitions and/or virtual petition signatures from non-constituents of a given elected official. For example, they may be visually distinguished by grouping, color and/or the ability to submit them, for example.

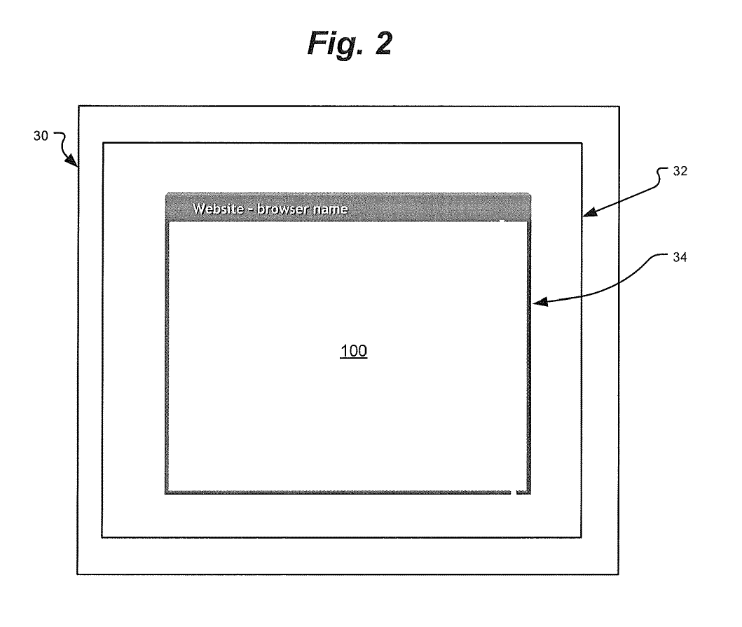

Referring now to FIG. 2, there is shown a block diagrammatic view of a portion of the system of FIG. 1 illustrating a provided website. In the illustrated embodiment, one or more of computing devices 30 include a display 32 presenting a website 100 via a browser application 34. Browser application 34 may be responsive to user interaction via the executing device 30 and/or computing devices 20 serving website 100 in a conventional manner.

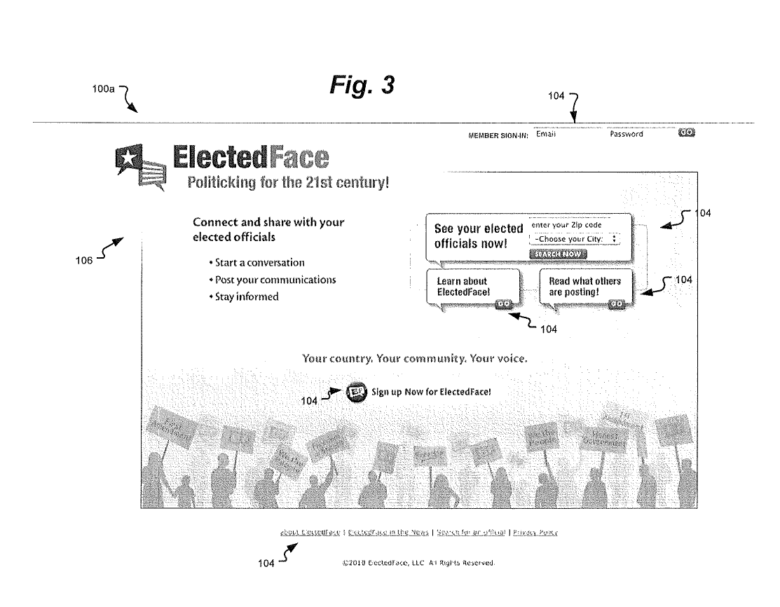

Referring now also to FIG. 3, an embodiment of a page 100a of website 100 is shown therein. Page 100a may be well suited to serve as a homepage of website 100 in certain embodiments of the invention. Page 100a may generally include navigation/data entry elements (e.g., links, textboxes, drop-lists . . . ) (hereinafter referred to as navigation elements) and/or content elements 106 (e.g., graphic, text, video and/or sound components). In the illustrated embodiment, page 100a includes navigation elements 104 which allow users to: sign in if they are registered members; find their elected officials and/or candidates; learn about the website; read other users' posts; sign up to become a registered member, read press about the website and see policies related to the website.

All pages herein may be part of website 100 or a website associated with website 100.

By way of further, non-limiting example only, users of computing devices 10, 30 may access devices 20 in a conventional manner, such as by using a conventional Internet connection and request website 100 via a conventional browser software functionality. Responsive thereto, page 100a may be provided and displayed to such requestors.

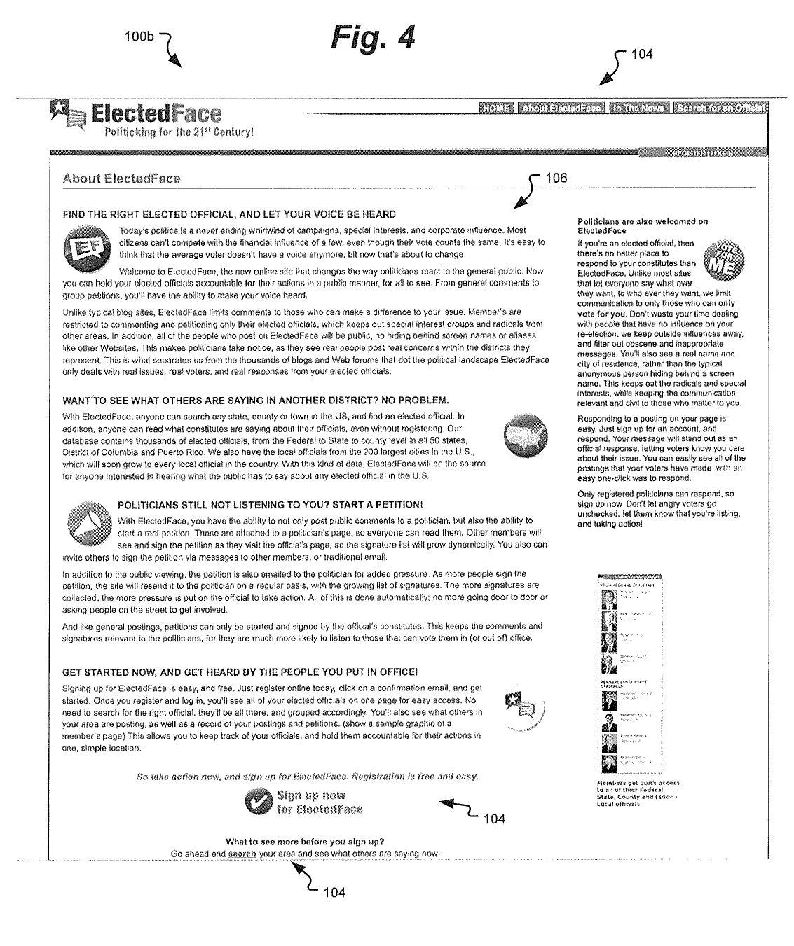

Referring now to FIG. 4, there is shown an embodiment of a page 100b of website 100. Page 100b may be well-suited for being presented when a user selects or otherwise activates a website navigation element corresponding to information about website 100 and/or its provider or services provided thereat or there-through. Page 100b may generally include navigation and/or content elements. In the illustrated embodiment of FIG. 4, navigation elements 104 allow users to: navigate to a homepage (e.g., to 100a); navigate to a page about the website (e.g., to 100b); read press about the website, such as by navigating to another page; search for elected officials and/or candidates, sign up to become a registered member; and log in as a registered member.

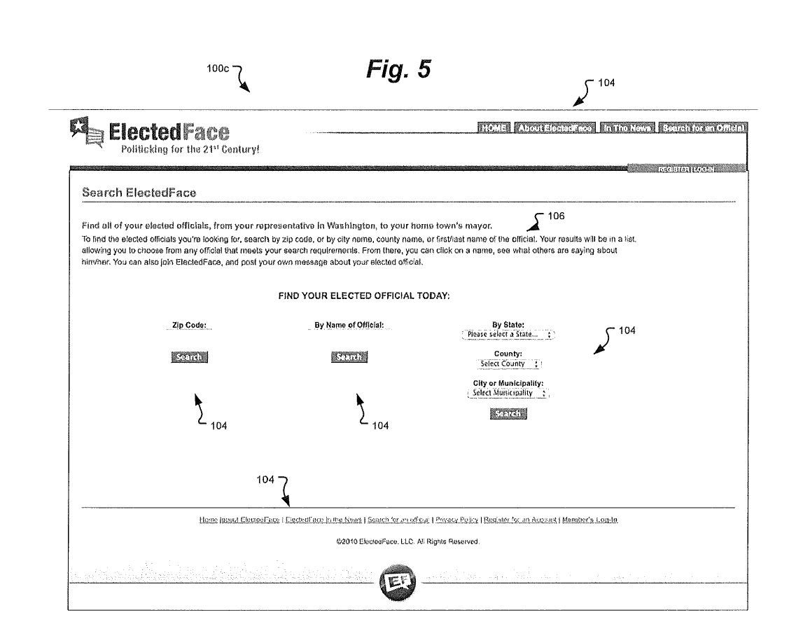

Referring now also to FIG. 5, there is shown an embodiment of a page 100c of website 100. Page 100c may be well suited for being presented when a user selects or otherwise activates a website navigation element corresponding to searching for an elected official and/or candidate. Page 100c may generally include navigation and/or content elements. In the illustrated embodiment of FIG. 4, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member; log in as a registered member; enter a zip code corresponding to an elected official and/or candidate to be searched; enter a name corresponding to an elected official and/or candidate to be searched; search by state, county and/or city or municipality.

For ease of discussion, candidates will hereinafter be considered as a type of “official” or “elected official” (even though not yet elected), and thus not discussed separately in connection with every embodiment. However, it should be clear that not all discussions about an official or elected official necessarily apply to candidates or vice-versa; for example, a search of current elected officials would not result in candidates being displayed, and a search of candidates would not yield an elected official who is not running for reelection.

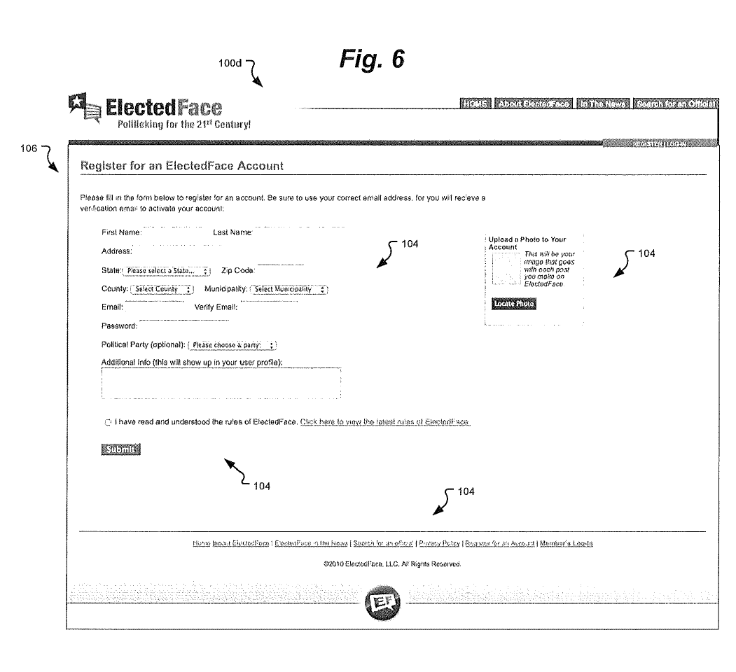

Referring now also to FIG. 6, there is shown an embodiment of a page 100d of website 100. Page 100d may be well-suited for being presented when a user selects or otherwise activates a website navigation element corresponding to signing up as a registered user. Page 100d may generally include navigation and/or content elements. In the illustrated embodiment of FIG. 6, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); and log in as a registered member, such as by navigating to a corresponding page; enter information to become a registered user (e.g., name, address, state, zip code, county, municipality, email address, password, political party, user name, and/or additional information such as an image, for example; and an acknowledgement as to having read applicable terms and/or conditions of use, as well as an element, in the case of FIG. 6 a button, to submit the information. Where no user name is provided for, such as in the illustrated case of FIG. 6, a unique or substantially unique registered user number may be assigned to each registered user, by way of further non-limiting example only.

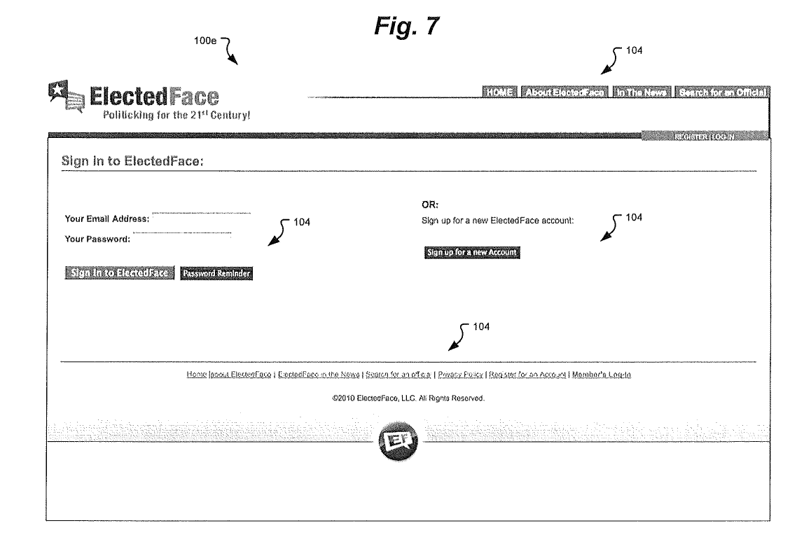

Referring now also to FIG. 7, there is shown an embodiment of a page 100e of website 100. Page 100e may be well-suited for being presented when a user selects or otherwise activates a website navigation element corresponding to logging in as a registered user. Page 100e may generally include navigation and/or content elements. In the illustrated embodiment of FIG. 7, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d; and log in as a registered member (e.g., 100e); enter at least some of the information previously submitted to become a registered user (e.g., email address and password; and as an element, in the case of FIG. 7 a button, to submit the information.

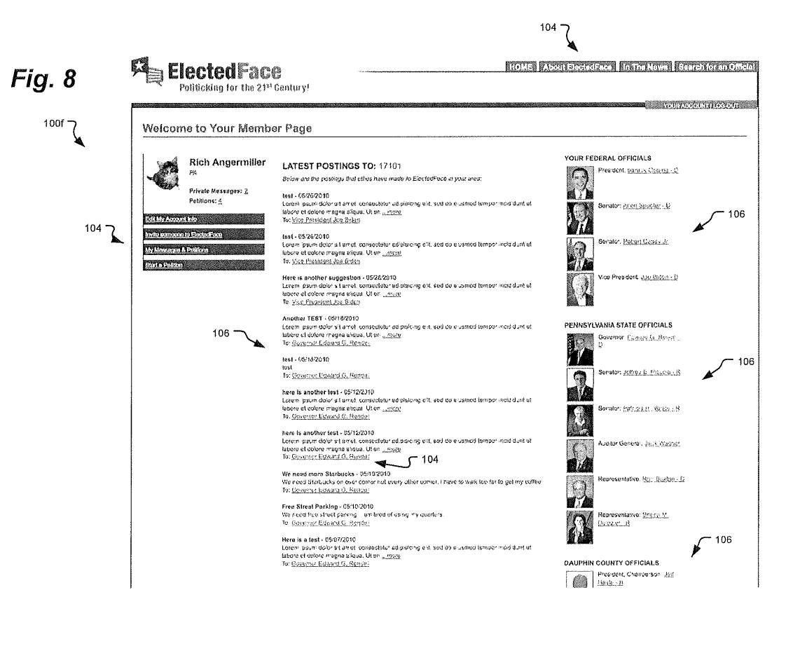

Referring now also to FIG. 8, there is shown an embodiment of a page 100f of website 100. Page 100f may be well-suited for being presented when a user has successfully signed in as a registered user and/or has entered criteria that can be used select various posts for presentation, for example (e.g., using 100e or 100c). Page 100f may generally include navigation and/or content elements. In the illustrated embodiment of FIG. 8, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); log in as a registered member (e.g., 100e); change account information associated with them (akin to that entered using 100d, for example; invite someone to the website 100 (such as by enabling them to send an email to such a person, for example); view messages and/or posts relevant to them (e.g., 100f), and start a petition.

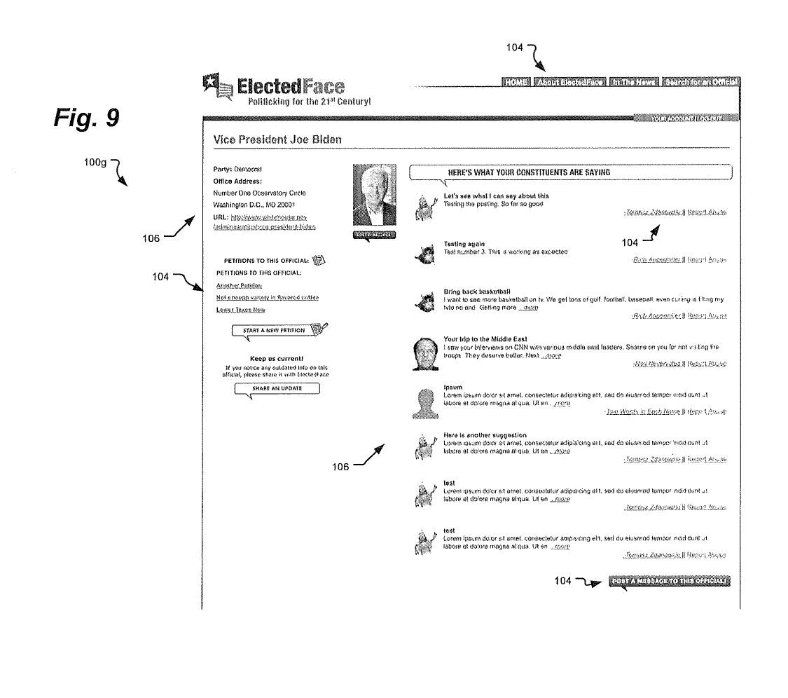

Referring now also to FIG. 9, there is shown an embodiment of a page 100g of website 100. Page 100g may be well-suited for being presented when a user has selected an official or candidate, for example (e.g., using 100f). Page 100g may generally include navigation and/or content elements. In the illustrated embodiment of FIG. 9, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); and log in as a registered member (e.g., 100e); change account information associated with them (akin to that entered using 100d, for example; invite someone to the website 100 (such as by enabling them to send an email to such a person, for example); start a petition, select a petition to virtually sign or otherwise endorse and post a message.

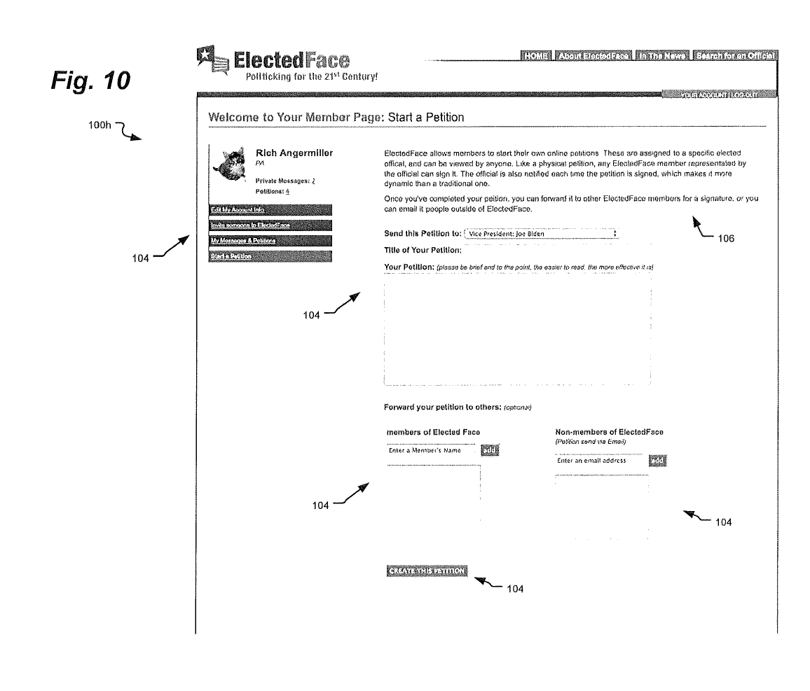

Referring now also to FIG. 10, there is shown an embodiment of a page 100h of website 100. Page 100h may be well-suited for being presented when a user has selected to start a petition (e.g., such as via page 100f or 100g). Page 100h may generally include navigation and/or content elements. In the illustrated embodiment of FIG. 10, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); and log in as a registered member (e.g., 100e); change account information associated with them (akin to that entered using 100d, for example); invite someone to the website 100 (such as by enabling them to send an email to such a person, for example); see messages or posts that relate to them and/or their elected officials and/or candidates; start a petition (e.g., 100h); select an official or candidate to send a petition to; name the petition; describe the petition; enter other persons to send the petition to (such as via email or intra-system messaging) and create the petition, such as by storing it in a database in accordance with the information provided.

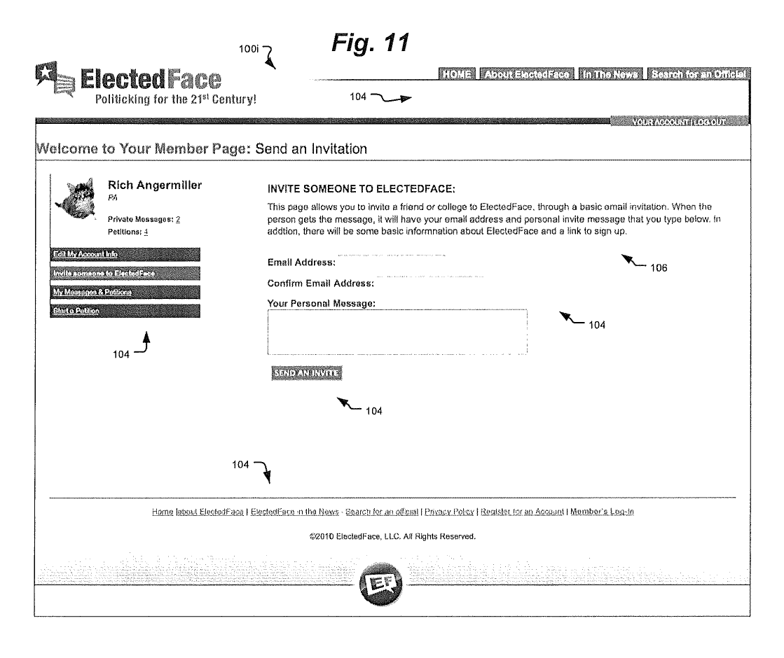

Referring now also to FIG. 11, there is shown an embodiment of a page 100i of website 100. Page 100i may be well-suited for being presented when a user has selected to send an invitation to someone else (e.g., such as via page 100h). Page 100i may generally include navigation and/or content elements. In the illustrated embodiment of FIG. 11, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); log in as a registered member (e.g., 100e); change account information associated with them (akin to that entered using 100d, for example); invite someone to the website 100 (such as by enabling them to send an email to such a person, for example); see messages or posts that relate to them and/or their elected officials and/or candidates; start a petition (e.g., 100h); enter an e-mail address corresponding to the intended invitee, enter a message for the intended invitee and send the invitation, thereby causing an automated e-mail message to be generated in accordance with the entered information.

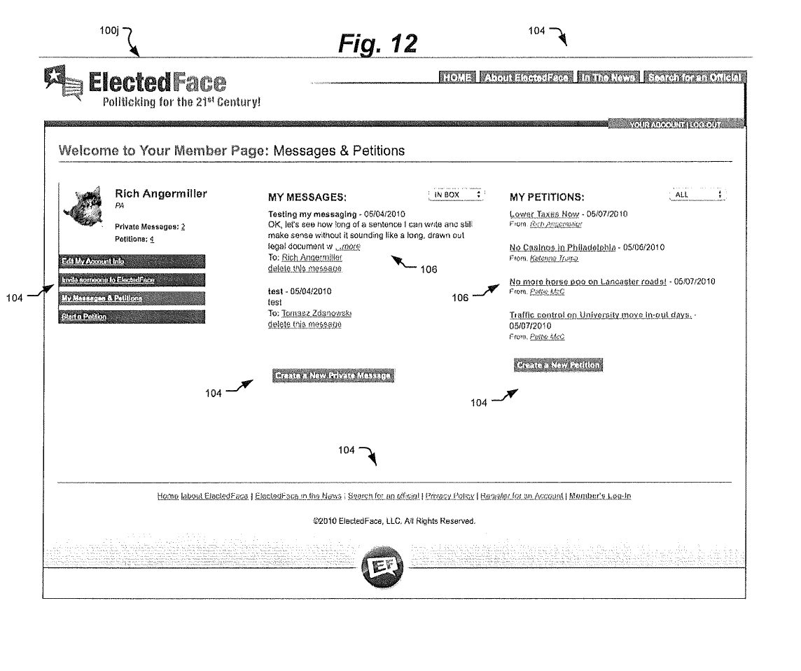

Referring now also to FIG. 12, there is shown an embodiment of a page 100j of website 100. Page 100j may be well-suited for being presented when a user has selected to see their messages (e.g., such as via page 100i). Page 100j may generally include navigation and/or content elements. In the illustrated embodiment of FIG. 12, navigation elements 104 allow users to: navigate to a homepage (e.g., 100a); navigate to a page about the website (e.g., 100b); read press about the website, such as by navigating to another page; search for elected officials and/or candidates (e.g., 100c), sign up to become a registered member (e.g., 100d); log in as a registered member (e.g., 100e); change account information associated with them (akin to that entered using 100d, for example); invite someone to the website 100 (e.g., 100i); see messages or posts that relate to them and/or their elected officials and/or candidates (e.g., 100j); start a petition (e.g., 100h); change between message subsets (e.g., akin to folders, like an inbox, outbox, sent . . . ); change between petition subsets (e.g., akin to folders, like an all, new, old . . . ); and create new messages and/or petitions.

By way of further, non-limiting example only, users of computing devices 10, 30 may access devices 20 in a conventional manner, such as by using a conventional Internet connection and request website 100 via a conventional browser software functionality. Responsive thereto, page 100a may be provided and displayed to such requestors.

Upon seeing page 100a, such a visitor may elect to search for their elected officials and/or candidates by populating the illustrated “enter your zip code now” box, choosing a city using the “choose your city” drop-box and activating the “search now” button. In such an event, a page akin to 100c may be launched.

Upon seeing page 100a, such a visitor may alternatively, or additionally, opt to select or otherwise activate a go button associated with a “learn more about [the website]” option (such that a page akin to 100b is launched) and/or a “read what others are posting!” button (such that a page akin to 100f, 100g is launched).

In the illustrated embodiment, a user may opt to sign in, using the “member sign-in” textboxes and “go” button, such that a page akin to 100e is presented, and/or sign-up to become a registered member using the “register” link, such that a page akin to 100d is presented. Once logged in, a page akin to 100f may be presented.

Still by way of non-limiting example, a user may then use the interface of page 100f to select one of their officials, e.g., a federal, state, county or municipal official or candidate, for example. In such an event, a corresponding page 100g for the selected official or candidate may be displayed.

Using such a page 100g, a user may see information about the official or candidate, such as party affiliation, office address and website. A user may also be presented with petitions that have been created by users and that relate to that official. A user may also see posts to and/or about that official or candidate. Additionally, a user may opt to post a message to or about the official or candidate using a “post a message to this official” button. In such an event, page 100g may be modified, and/or another page presented in a conventional manner (e.g., akin to the petitions page 100h), to allow the user to create a new post that will then appear in the posts to and/or about that official or candidate displayed on the official's page 100g.

By way of further non-limiting example, a user viewing page 100a, may click a navigation element to “surf” to page 100b, to learn about the website and/or its operator. A user viewing page 100a, may click a navigation element to “surf” to page 100c, to find an elected official and/or candidate for election. A user viewing page 100a, may click a navigation element to “surf” to a page that lists stories and/or press releases regarding the website and/or its operator.

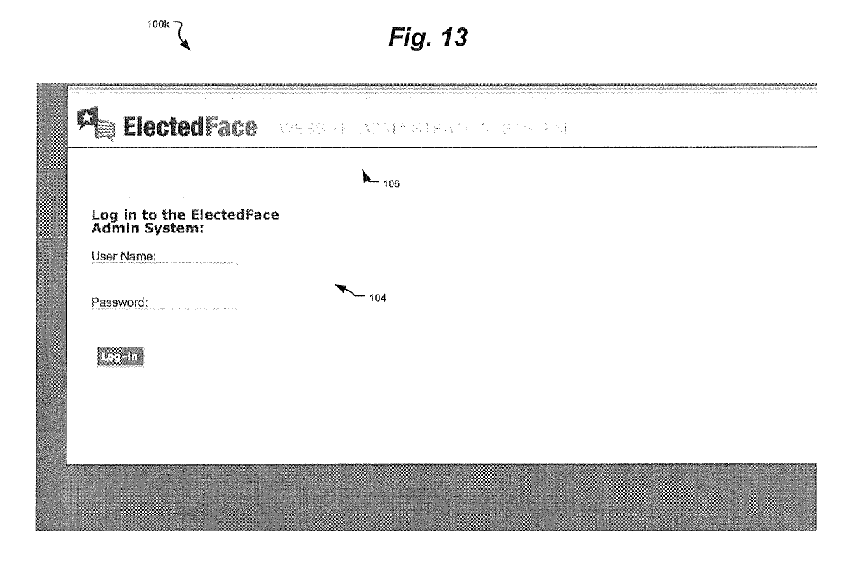

Referring now also to FIG. 13, there is shown an embodiment of a page 100k corresponding to website 100. Page 100k may be part of website 100 or a website associated with website 100. Page 100k may be well-suited for being presented when an administrative user of website 100 desires to log in to administrate website 100. Page 100k may generally include navigation and/or content elements. In the illustrated embodiment of FIG. 13, navigation elements 104 allow users to log into an administrative portal corresponding to website 100 in a conventional manner.

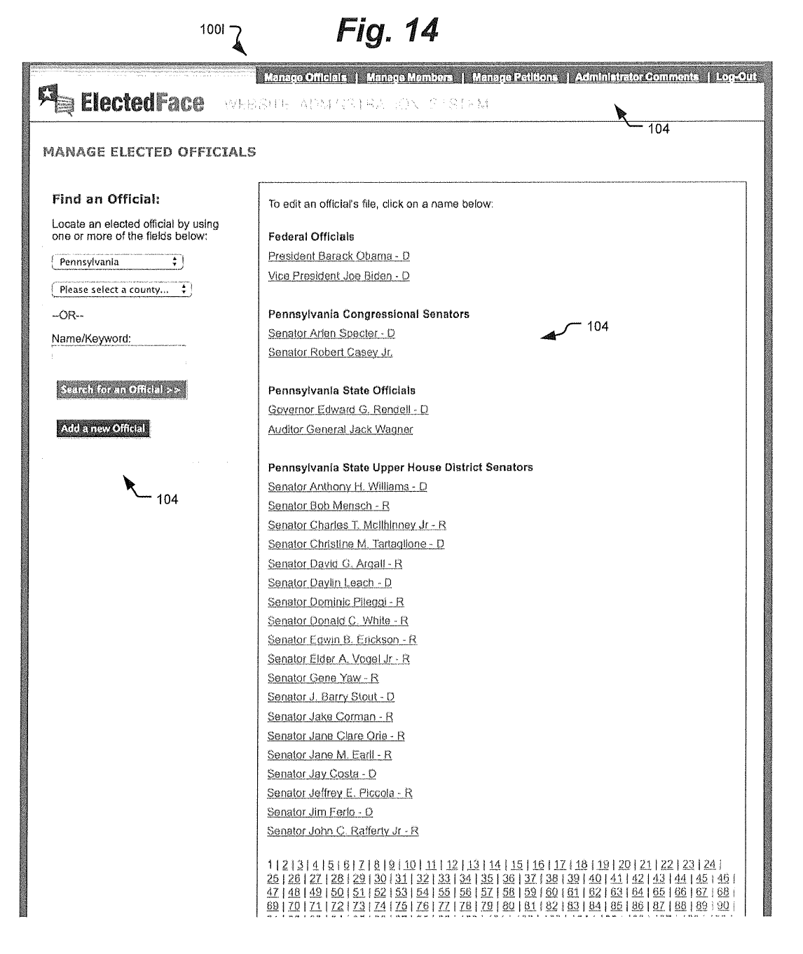

Referring now also to FIG. 14, there is shown an embodiment of a page 100l corresponding to website 100. Page 100l may be part of website 100 or a website associated with website 100. Page 100l may be well-suited for being presented when an administrative user of website 100 logs in to administrate website 100 (e.g., using 100k). Page 100l may generally include navigation and/or content elements. In the illustrated embodiment of FIG. 14, navigation elements 104 allow users to manage officials and/or candidates of website 100, manage members of website 100, manage petitions of website 100, provide comments, and log out. Page 100l additionally allows for a user to search for officials/candidates and add new officials/candidates.

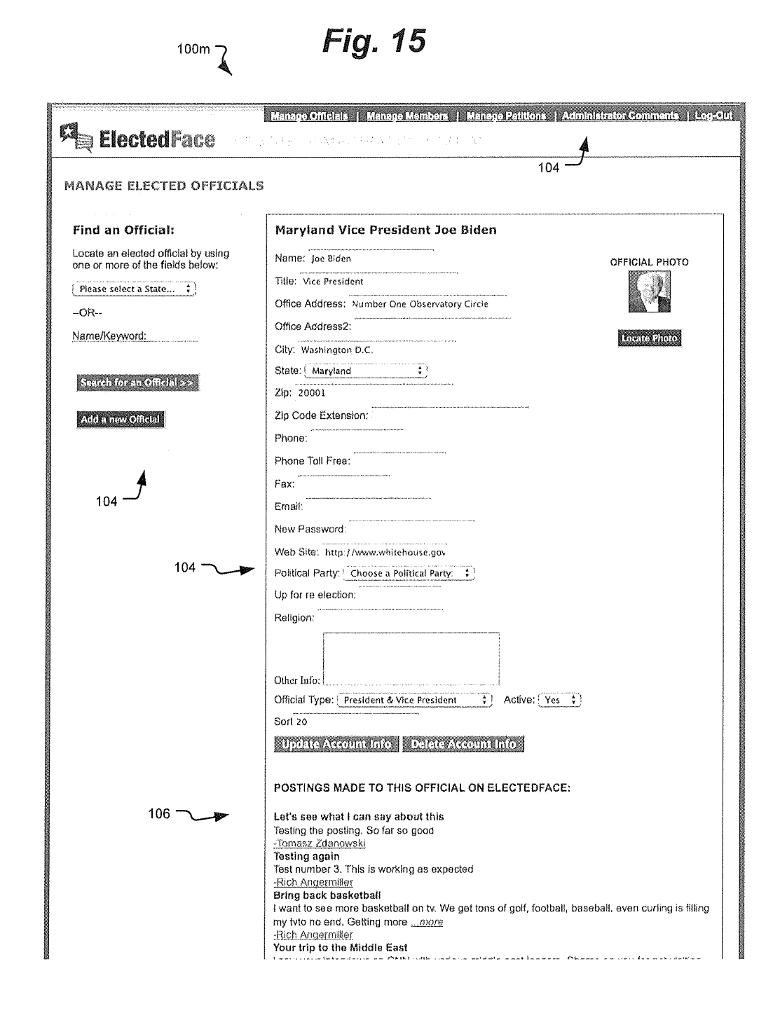

Referring now also to FIG. 15, there is shown an embodiment of a page 100m corresponding to website 100. Page 100m may be part of website 100 or a website associated with website 100. Page 100m may be well-suited for being presented when an administrative user of website 100 selects a candidate/official to check, change or delete information about (e.g., using 100l). Page 100m may generally include navigation and/or content elements. In the illustrated embodiment of FIG. 15, navigation elements 104 allow users to manage officials and/or candidates of website 100, manage members of website 100, manage petitions of website 100, provide comments, and log out. Page 100m additionally allows for a user to search for officials/candidates and add new officials/candidates. Additionally, page 100m allows a user to enter information to be presented (e.g., as elements 106) regarding officials, such as name, title, address, phone, fax, email, website, political party, religion, and/or other types of information. Additionally, page 100m allows a user to change such a politician's password, to log into the system.

Entered information may be stored in one or more databases included in or accessible to devices 20 (FIG. 1), for use in populating website 100 in a conventional manner.

In the illustrated case of FIG. 15, recent comments of other users regarding the subject politician are also shown. Posts, when entered, may similarly be stored in one or more databases included in or accessible to devices 20 (FIG. 1), for use in populating website 100 in a conventional manner.

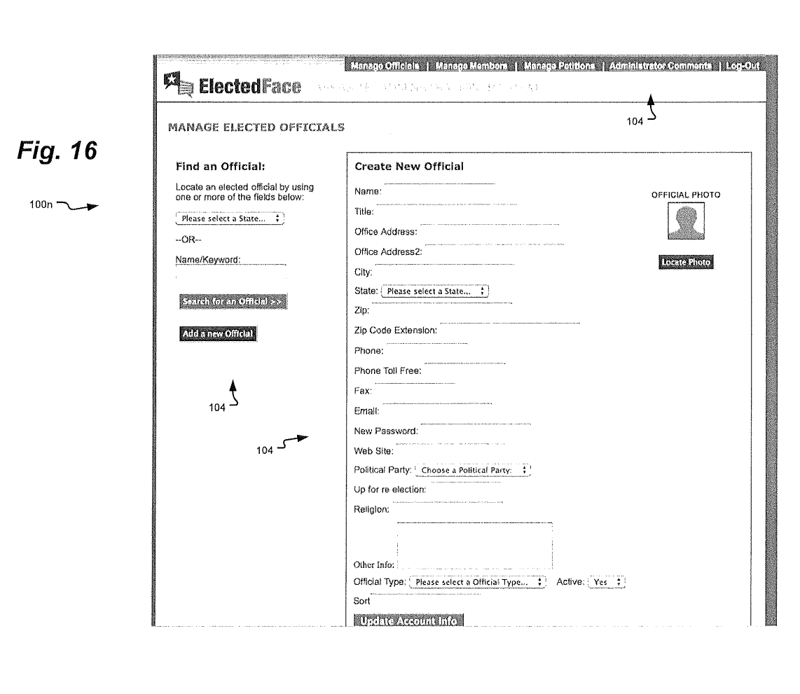

Referring now also to FIG. 16, there is shown an embodiment of a page 100n corresponding to website 100. Page 100n may be part of website 100 or a website associated with website 100. Page 100m may be well-suited for being presented when an administrative user of website 100 selects a candidate/official to add information about (e.g., using 100l). Page 100n may generally include navigation and/or content elements. In the illustrated embodiment of FIG. 16, navigation elements 104 allow users to manage officials and/or candidates of website 100, manage members of website 100, manage petitions of website 100, provide comments, and log out. Page 100n additionally allows for a user to search for officials/candidates and add new officials/candidates. Additionally, page 100n allows a user to enter information to be presented (e.g., as elements 106) regarding officials, such as name, title, address, phone, fax, email, website, political party, religion, and/or other types of information. Additionally, page 100m allows a user to change such a politician's password, to log into the system.

Entered information may be stored in one or more databases included in or accessible to devices 20 (FIG. 1), for use in populating website 100 in a conventional manner.

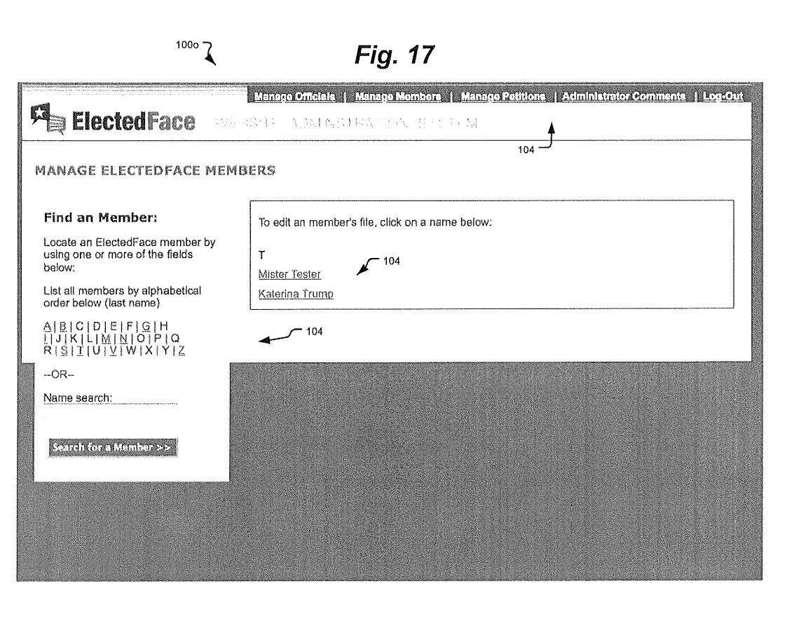

Referring now also to FIG. 17, there is shown an embodiment of a page 100o corresponding to website 100. Page 100o may be part of website 100 or a website associated with website 100. Page 100o may be well-suited for being presented when an administrative user of website 100 desires to find a registered user (e.g., using 100l). Page 100o may generally include navigation and/or content elements. In the illustrated embodiment of FIG. 17, navigation elements 104 allow users to manage officials and/or candidates of website 100, manage members of website 100, manage petitions of website 100, provide comments, and log out. Page 100o additionally allows for a user to search for registered members in an analogous method to those presented above. For example, registered members may be listed in a predefined order, such as alphabetically, and/or be searchable.

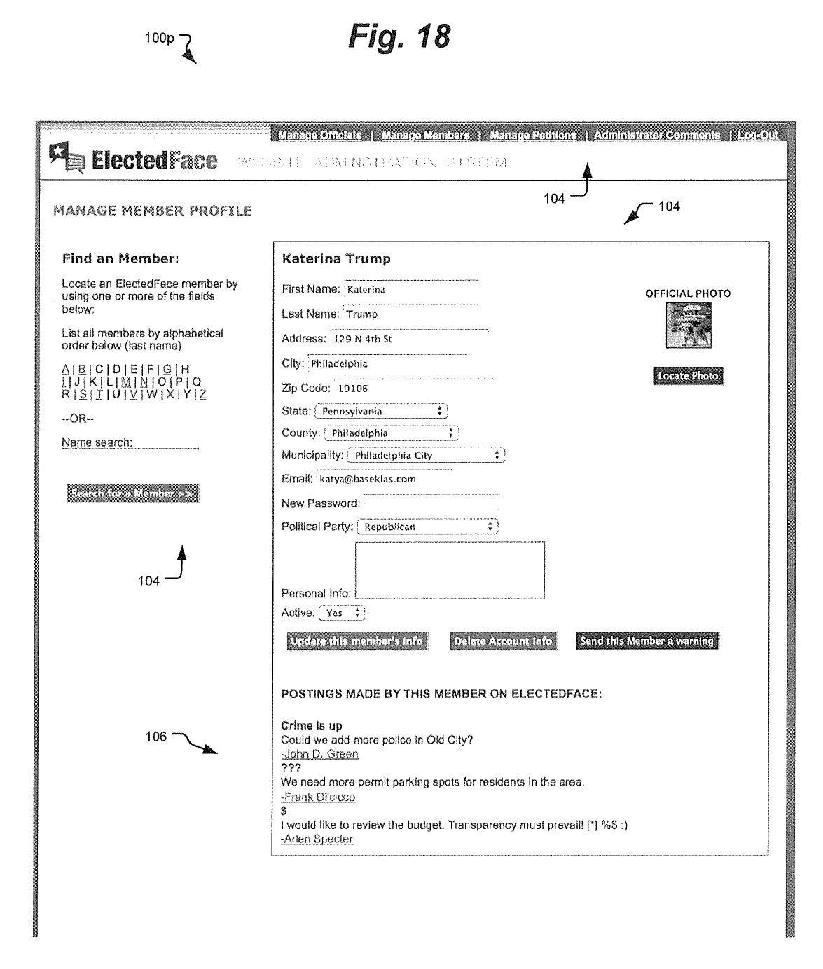

Referring now also to FIG. 18, there is shown an embodiment of a page 100p corresponding to website 100. Page 100p may be part of website 100 or a website associated with website 100. Page 100p may be well-suited for being presented when an administrative user of website 100 selects a registered member to change information about (e.g., using 100o). Page 100p may generally include navigation and/or content elements. In the illustrated embodiment of FIG. 18, navigation elements 104 allow users to search for and manage registered users of website 100, by for example, allowing administrative users to enter and/or change name, address, email, password, political party affiliation and/or other information regarding registered users.

Page 100p also includes button for allowing a user to be deleted from the site, e.g., unregistered by deleting them from the registered users database, and/or flagging one or more subject accounts as inactive. Page 100p also includes a button for allowing a user to be sent an email warning them regarding the use of the site.

Entered information may be stored in one or more databases included in or accessible to devices 20 (FIG. 1), for use in populating website 100 in a conventional manner.

In the illustrated case of FIG. 18, recent comments or posts of a subject user are also shown.

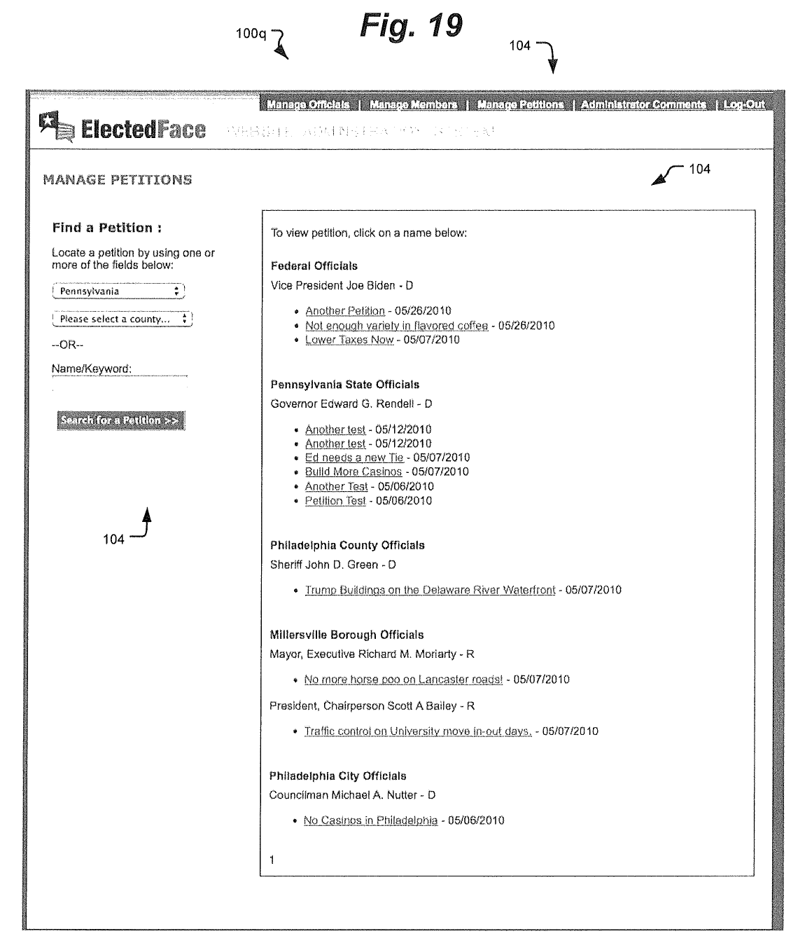

Referring now also to FIG. 19, there is shown an embodiment of a page 100q corresponding to website 100. Page 100q may be part of website 100 or a website associated with website 100. In the illustrated embodiment of FIG. 19, navigation elements 104 allow users to manage officials and/or candidates of website 100, manage members of website 100, manage petitions of website 100, provide comments, and log out. Page 100q additionally allows for a user to search for officials/candidates and add new officials/candidates. Additionally, page 100q allows a user to search for and find petitions regarding politicians and political areas, such as nation, state, county and municipality.

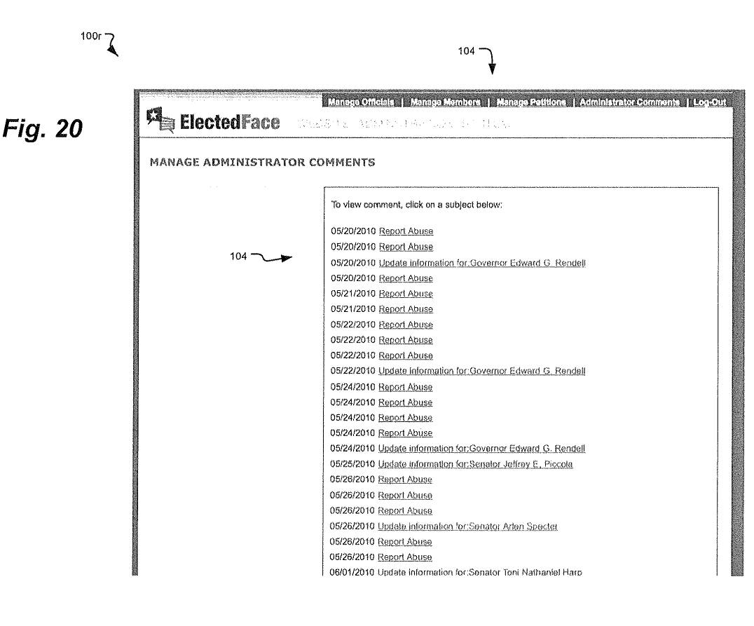

Referring now also to FIG. 20, there is shown an embodiment of a page 100r corresponding to website 100. Page 100r may be part of website 100 or a website associated with website 100. In the illustrated embodiment of FIG. 20, navigation elements 104 allow users to manage officials and/or candidates of website 100, manage members of website 100, manage petitions of website 100, provide comments, and log out. Page 100r additionally allows for an administrative user to manage communications, such as abuse reports, associated with website 100.

By way of non-limiting further explanation, if a user of website 100 believes the system is being abused, such as via what he/she deems to be inappropriate posts or petitions, they may opt to report system abuse, such as by activating a “Report Abuse” link (e.g., 100g). An entry in a database part of or accessible to devices 20 may be generated responsively to such a link activation.

Upon requesting page 100r, such as by activating an “Administrative Comments” link (e.g., 100l), such a database may be used to populate page 100r. An administrative user may use the administrative pages discussed herein to investigate and take appropriate action regarding such reports, such as ignoring the report, deleting a post and/or warning or deleting a registered user. Other changes to the system databases may also be logged, for example.

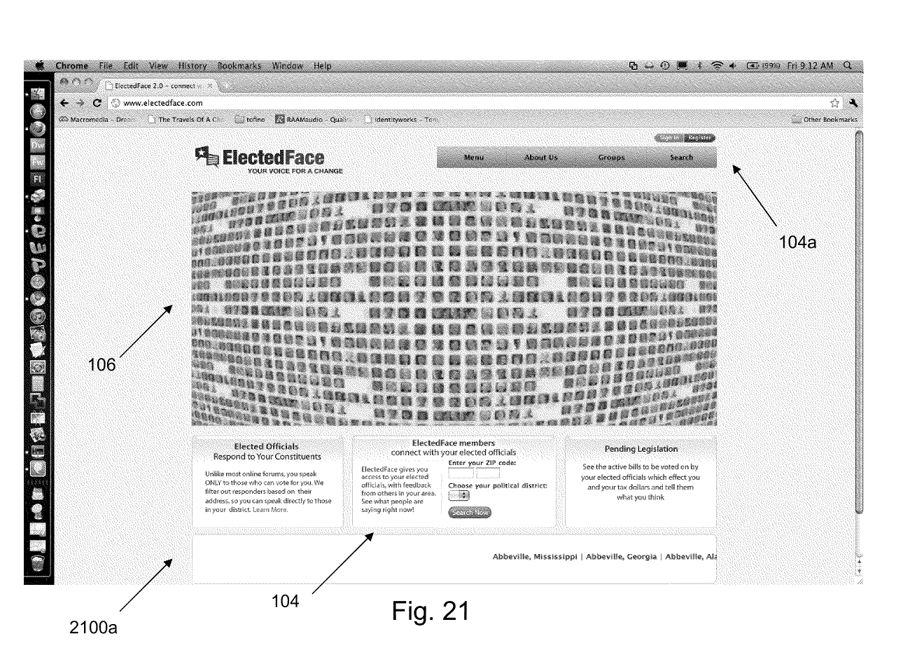

Referring now to FIG. 21, another embodiment of a page 2100a of website 100 is shown therein. Page 2100a may be well suited to serve as a homepage of website 100 in certain embodiments of the invention. Page 2100a may generally include navigation/data entry elements 104 (e.g., links, textboxes, drop-lists . . . ) (hereinafter referred to as navigation elements) and/or content elements 106 (e.g., graphic, text, video and/or sound components). In the illustrated embodiment, page 2100a includes navigation elements 104 which allow users to: sign in if they are registered members; find their elected officials and/or candidates; learn about the website; search the website; sign up to become a registered member; read press about the website; see policies related to the website; access Groups on the website; and access a menu of other options. Several of the navigation elements that are common to several different public pages of the website are organized together in a first cluster 104a.

Page 2100a provides an option for a visitor to search for their elected officials and/or candidates, which a visitor can search by populating one or more fields and activating the “search now” button. Page 2100a provides non-limiting examples of such fields in the form of “enter your zip code now” box, or “choose your political district.” Other non-limiting options for search may include choosing a city, state, municipality, etc. Still another option would be to enter a phone number, for which a location could be derived and corresponding elected officials identified. Options could also be provided to limit the search by federal, state and/or local governments.

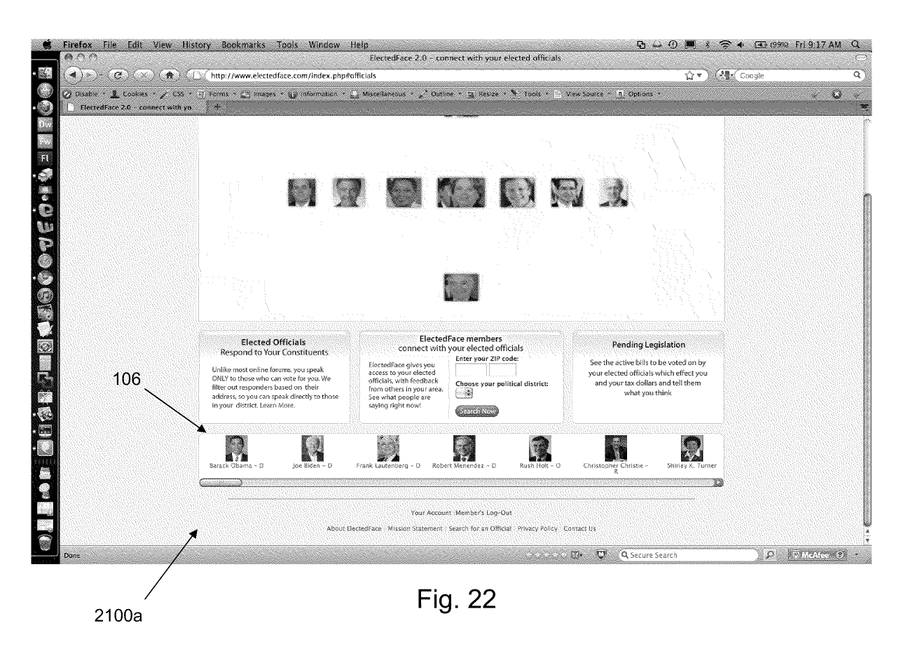

FIG. 22 shows the bottom portion of page 2100a populated by search results in the form of a horizontal line of the pictures of the corresponding elected officials, along with their names and political parties; however, the invention is not so limited, and other presentation formats and/or information displayed about each candidate can be used. The pictures are preferably organized from highest office to lowest office such that the President is followed by the Vice President, etc., but again the invention is not so limited, and other formats can be used. Each picture, name, and/or other elected official data preferably acts as a link to a webpage about that specific official, discussed in more detail below.

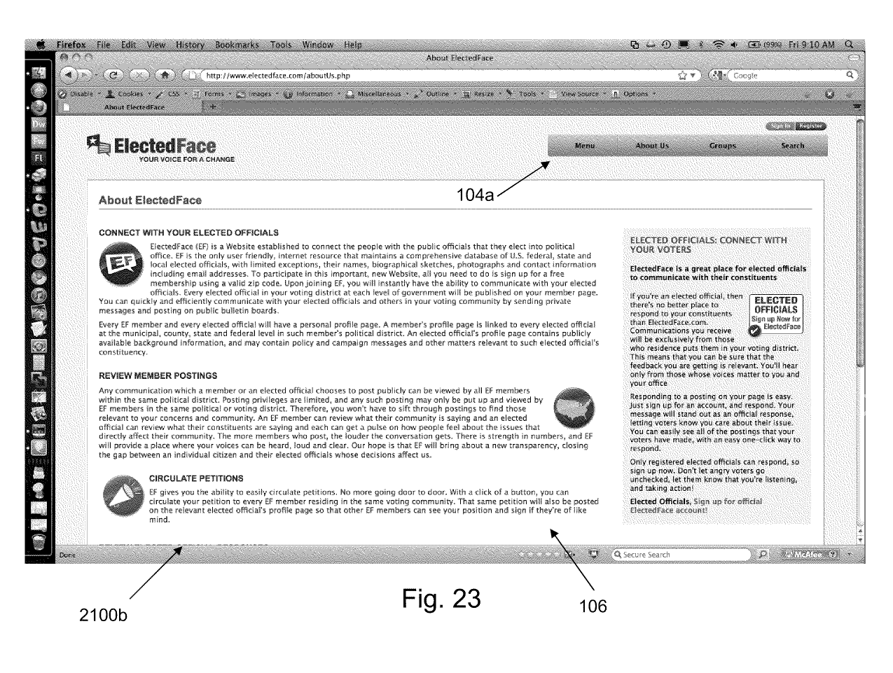

Referring now to FIG. 23, there is shown an embodiment of a page 2100b of website 100. Page 2100b may be well suited for being presented when a user selects or otherwise activates a website navigation element corresponding to information about and functionality of website 100 and/or its provider or services provided thereat or there through (the link “About us” in page 2100a being a non-limiting example of the same). Page 2100b may generally include navigation elements 104 and/or content elements 106, including first cluster 104a of navigation elements that are common to multiple web pages.

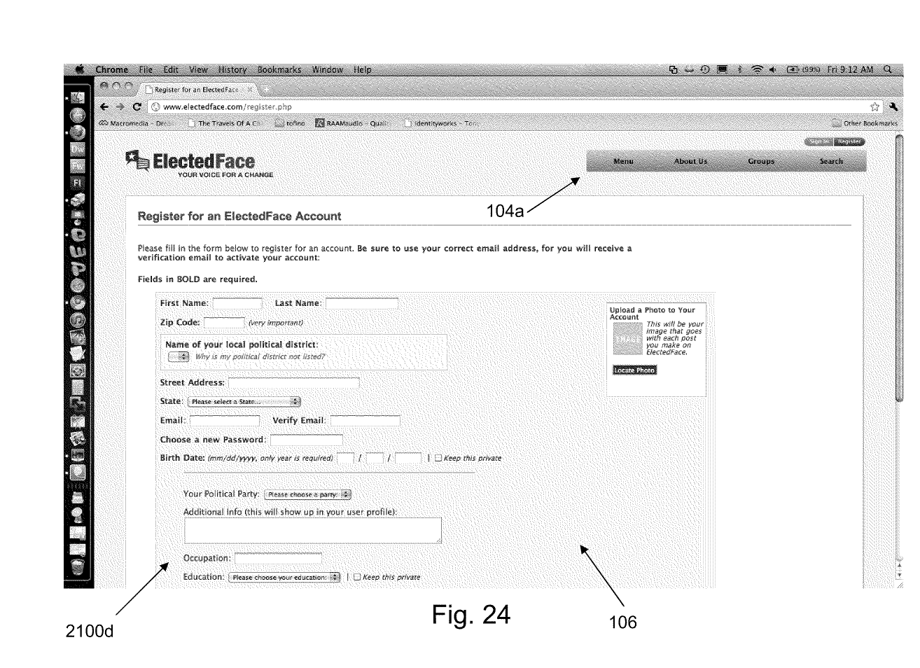

Referring now also to FIG. 24, there is shown an embodiment of a page 2100d of website 100. Page 2100d may be well suited for being presented when a user selects or otherwise activates a website navigation element corresponding to registering as a user. Page 2100d may generally include navigation and/or content elements, including first cluster 104a, to provide fields that the user can populate with identification information and/or preference information to establish a member profile.

The system uses the personal information provided by the member to determine the corresponding officials. Every government elected office has corresponding geographic boundaries that are defined by controlling law, and which change from time to time. People who are legally recognized to reside within a boundary of a particular office define the constituency for that office. Once a user establishes a profile and formally registers as a member, the system cross-references the member's entered personal data, such as an address or phone number, with the boundaries of the various offices to determine what constituencies the member belongs to.

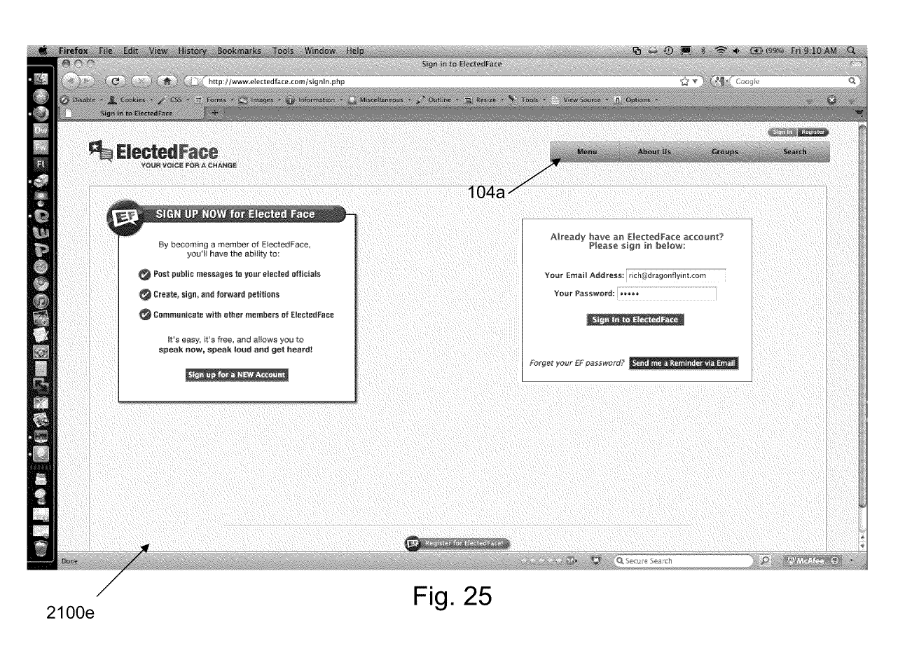

Referring now also to FIG. 25, there is shown an embodiment of a page 2100e of website 100. Page 2100e may be well suited for being presented when a user selects or otherwise activates a website navigation element corresponding to logging in as a registered user. In the illustrated embodiment of FIG. 25, navigation elements 104 allow members to log in as a registered member (e.g., 2100e) by entering at least some of the information previously submitted to become a registered user (e.g., email address and password). Successful sign in directs the user to the member's private page 2100f (discussed below) or Group page 2100p (discussed below) if the user is a Group Leader/Coordinator. Page 2100e may generally include navigation elements 104 and/or content elements 106, including cluster 104a.

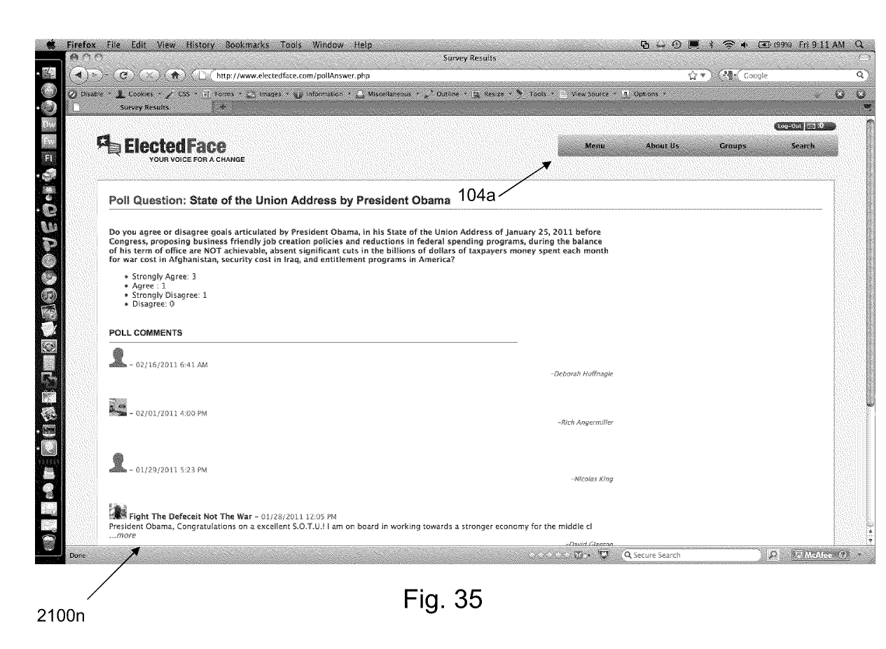

In the alternative, once the user logs in, before the system passes to a profile page the system can first direct the user to a universal survey page for the site. Referring now also to FIG. 35, there is shown an embodiment of a page 2100n of website 100. Page 2100n may be well suited for being presented when the system presents a poll or survey. This is preferably a simple question created by the system Administrator, and preferably be answered by a simple yes, no, or ‘Unsure’ answer; however, more complicated questions and/or answer options (such as range of agreement or disagreement) could also be used. The member can either answer the survey or skip ahead to the member profile page. Preferably, once a member answers the survey, the page should no longer appear when they log in. Preferably, only a new survey question should trigger the survey page to show during a subsequent log in. However, the invention is not so limited, and multiple questions, either at log in or at different processing junctures, can be used.

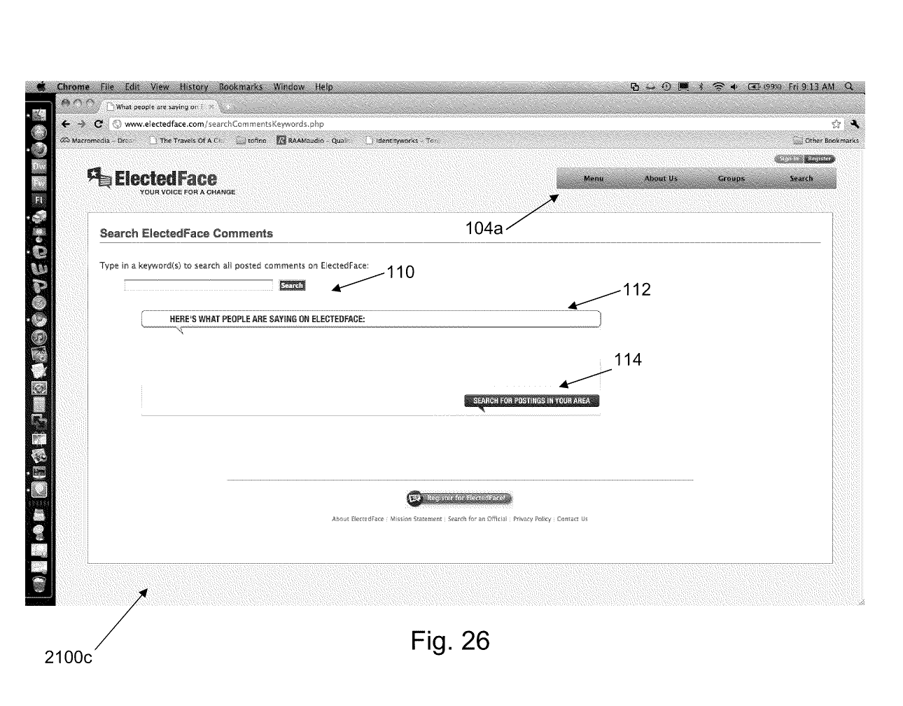

Referring now also to FIG. 26, there is shown an embodiment of a page 2100c of website 100, which can be reached via the “Search” navigation element 104 found in cluster 104a. Page 2100c includes a search field 110 for which a user can enter desired search terms. This allows users (members and non-members) to search all of the posts on the website based on one or more selected parameters. Once a user selects the search parameters, the results will publish on a basic page template, preferably in order of relevance. Sever 20, using standard search protocols, can identify relevant posts and provide them for display in display field 112. Results may be based on the frequency of the topic name; the more times it is listed in a posting, the higher up the posting may show on the results page, etc. For postings with the same number of topic words, the latest posting can appear first. Search results can include a “more” link to show the full posting, as well as a link to that elected official's page.

Various navigation elements 104, such as “Search for postings in your area” button 114, can narrow the scope of the search by one or more factors. Although the invention is not limited to any particular search parameters, typical examples might include time frame, elected official or candidate to whom the post was made and/or directed, political affiliation, general geographic limitations, political geographic limitations (i.e., a county or state), etc. Page 2100c may generally include navigation elements 104 and/or content elements 106, including cluster 104a.

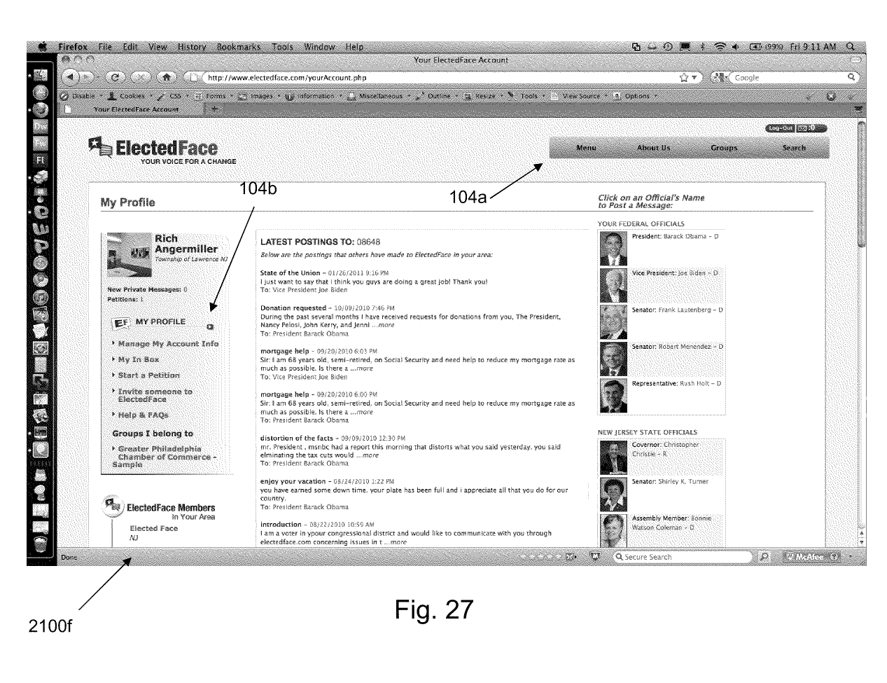

Referring now to FIG. 27, page 2100f may be well-suited for being presented when a user has successfully signed in as a registered user and/or has entered criteria that can be used select various posts for presentation (e.g., using 2100e or 2100c). Page 2100f is preferably a personal member profile page that is visible to only to the member and not the general public. Page 2100f may generally include navigation and/or content elements, including cluster 104a. Non-limiting examples of content 106 include: the user's name and geographical information; latest postings; Groups that the member has joined; other registered users who are located within a certain geographic distance and/or political boundary from the user's registered address; and the officials for which the user is a constituent. Page 2100f can also include a local political news feed that is based on RSS feeds which are filtered to identify and present feeds focused on local political content (“local” typically being determined based on the members zip code relative to zip codes associated with the RSS feed, but other methods could be used).

In the illustrated embodiment of FIG. 27, second cluster 104b of navigation elements 104 is directed to specific functionality of the member's private profile. Cluster 104b includes links to: manage account information associated with them (akin to that entered using 2100d, for example); invite someone to the website 100 (such as by enabling them to send an email to such a person, for example); start a petition; view messages and/or posts relevant to them (e.g., 2100f); start a petition; help and questions; and Groups that the member has joined. Second cluster 104b is preferably in the same format for all private pages that are specific to an individual member. The displayed information on the elected officials doubles as links to reach the page for the corresponding official.

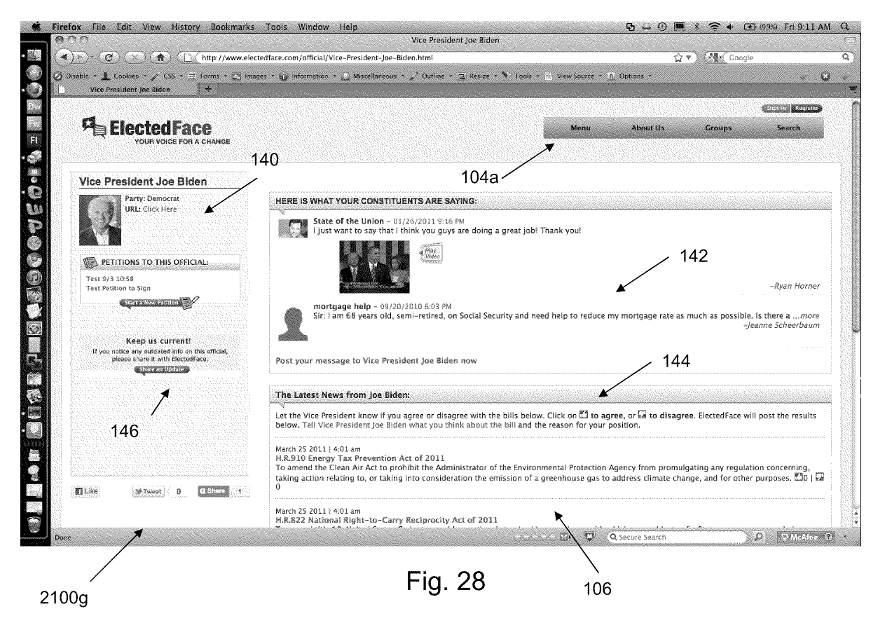

Referring now also to FIG. 28, there is shown an embodiment of a page 2100g of website 100. Page 2100g may be well suited for being presented when a user has selected an official, for example from page 2100a (after a search) or page 2100f. Page 2100g may generally include navigation and/or content elements, including cluster 104a as described above. Content 106 includes information 140 on the official, received posts 142 from the official's constituency, posts 144 by the official, and active petitions 146. The page may also have embedded links to videos sponsored by the official, such as a welcome video, summary of issues, official's views on a certain topic, etc.

Another navigational element 104 in page 2100g allows members to post a petition to a specific elected official. This can be done, by way of non-limiting example, by clicking on a link called “start a new petition” as located on each elected official's page 2100g. From there, the member will get a “start a petition” page 2100h (discussed below), allowing them to enter data to create the petition.

The system can contact the official, preferably by email, informing or reminding the elected official that there is a live petition made to him/her. The communication can be as simple as a short message, contain a link to reach the petition page, and/or contain detailed information such as the petition process, a copy of the petition's content, and the latest tally of signatures. This way, an elected official is reminded often on how popular a petition is, potentially prompting them to take responsive action. The system may allow the official to post a response to the petition. Preferably, these reminders can be sent according to a time or parameter schedule; by way of non-limiting example, a communication can be sent for every 10^{th} name that is signed. The schedule can also be progressive rather than linear, such that messages are sent at the first, tenth, hundredth, thousandth, etc., signature; however, the invention is not limited to any particular schedule.

Much of the above disclosure has been directed to members as a specific type of user of website 100. Officials may also register in the system as a different type of member. Their membership will be similar to regular members, except that they can preferably only respond to postings or petitions made on their page 2100g. When an official makes a response, it may carry a unique format, for users can easily see their response.

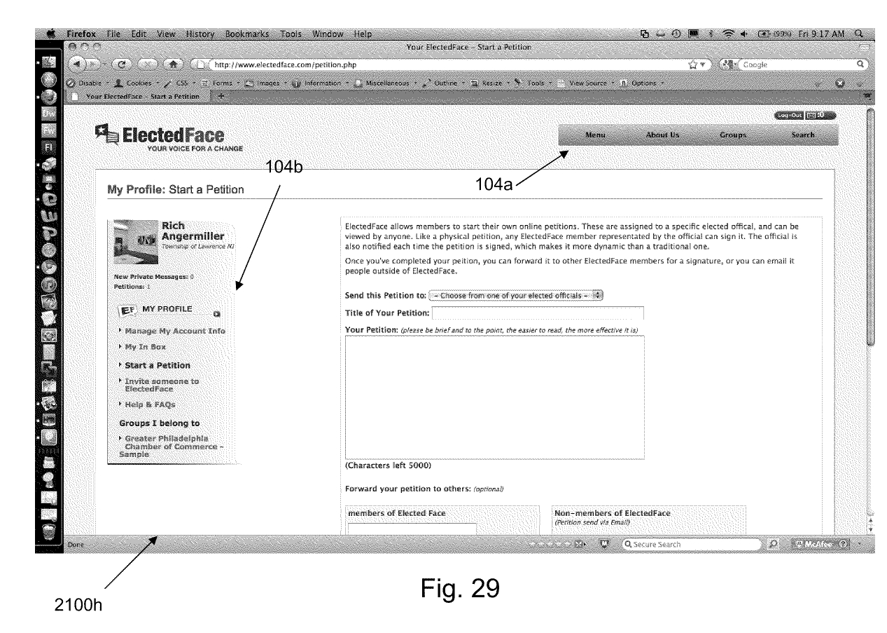

Referring now also to FIG. 29, there is shown an embodiment of a page 2100h of website 100. Page 2100h may be well suited for being presented when a user has selected to start a petition (e.g., such as via page 2100f or 2100g). Page 2100h may generally include navigation and/or content elements. In the illustrated embodiment of FIG. 10, navigation elements 104 includes the first cluster 104a and the second cluster 104b as described above. Petition specific navigation elements 104 and/or fields are also provided, including: select an official to send a petition to; name the petition; describe the petition; enter other persons to send the petition to (such as via email or intra-system messaging); and create the petition, such as by storing it in a database in accordance with the information provided.

A live petition can be accessible in multiple web pages. One possible page is, as noted above, the page 2100g of the relevant official. Members can also link to petitions they created or signed though their account page 2100f, which can provide a running list in a subsection called “petitions.” Each petition subsection can include the names of the members who have signed it, such that the list of names is dynamic.

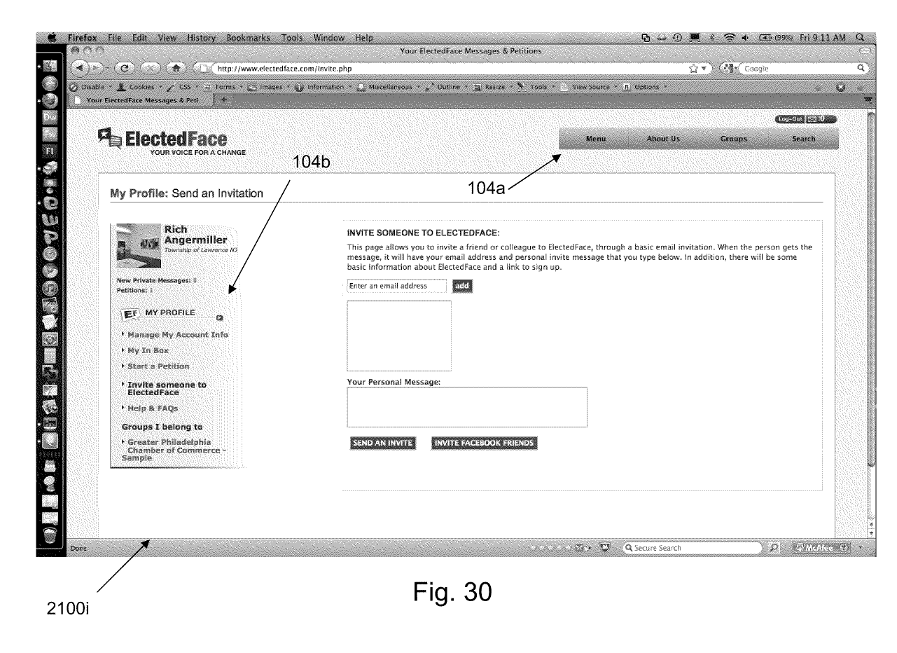

Referring now also to FIG. 30, there is shown an embodiment of a page 2100i of website 100. Page 2100i may be well suited for being presented when a user has selected to send an invitation to someone else (e.g., such as via page 2100h). Page 2100i may generally include navigation and/or content elements, including first and second clusters 104a and 104b as described above. Invitation specific navigation elements 104 and/or fields are also provided, including: invite someone to the website 100 (such as by enabling them to send an email to such a person or via FACEBOOK, for example); see messages or posts that relate to them and/or their elected officials and/or candidates; start a petition (e.g., 2100h); enter an e-mail address corresponding to the intended invitee; and/or enter a message for the intended invitee and send the invitation, thereby causing an automated e-mail message to be generated in accordance with the entered information.

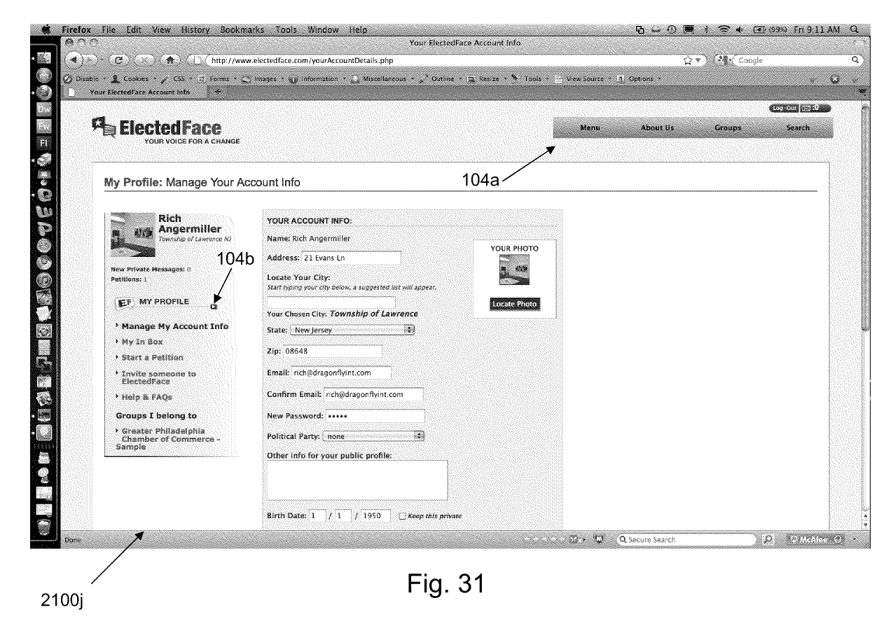

Referring now also to FIG. 31, there is shown an embodiment of a page 2100j of website 100. Page 2100i may be well suited for being presented when a user has selected to manage the user's account information, which may be accessed for example via a link within the second cluster 104b. Page 2100i may generally include navigation and/or content elements, including first and second clusters 104a and 104b as described above. Management specific navigation elements 104 and/or fields are also provided, including: name, address, email, passwords, political profile, birth date and/or user comments.

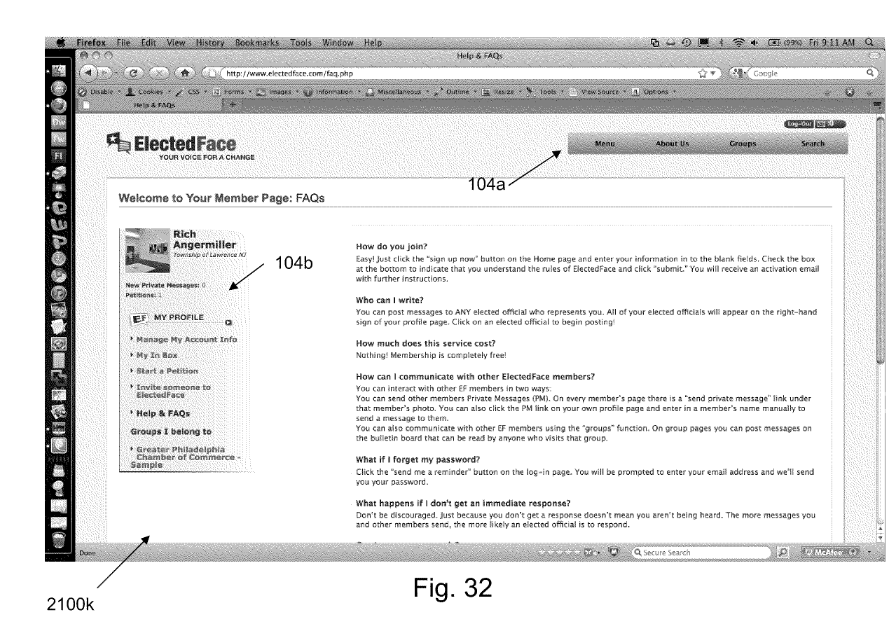

Referring now also to FIG. 32, there is shown an embodiment of a page 2100k of website 100. Page 2100k may be well-suited for being presented when a user has selected to access help and frequently asked questions, which may be accessed for example via a link within the second cluster 104b. Page 2100i may generally include navigation and/or content elements, including first and second clusters 104a and 104b as described above. Content 106 may include frequently asked questions and answers. Additional navigation elements 104 (not shown) may provide links and/or fields for a user to search help forums and/or contact the support operations of website 100 for further assistance.

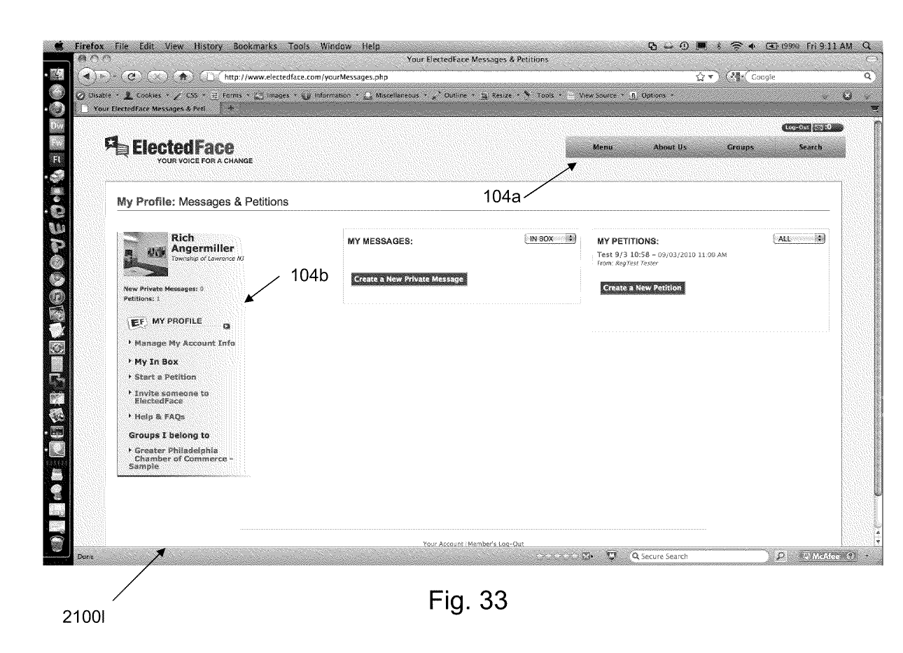

Referring now also to FIG. 33, there is shown an embodiment of a page 2100l of website 100. Page 2100l may be well suited for being presented when a user has selected to see their messages (e.g., such as via the “My Inbox” link in second cluster 104 that may be present in the member specific pages. Page 2100i may generally include navigation and/or content elements, including first and second clusters 104a and 104b as described above. Additional navigation elements 104 may provide links and/or fields for a user to change between message subsets (e.g., akin to folders, like an inbox, outbox, sent . . . ), change between petition subsets (e.g., akin to folders, like an all, new, old . . . ) and create new messages and/or petitions.

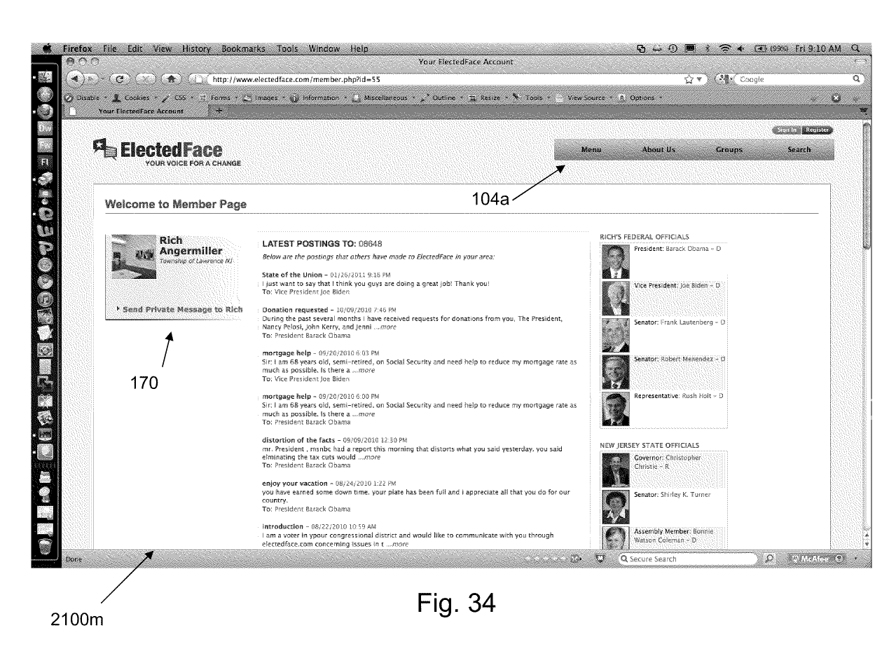

The above-noted pages for members are preferably private and accessible only by the specific member. Referring now to FIG. 34, a public member page 2100m is accessible by other visitors to website 100. Public member page 2100m as shown is similar in format and content to profile member page 2100f, although the second cluster of links 104b is not provided due to a lack of public access. In the alternative, second cluster 104b could be provided visually, with the links disabled.

Page 2100m includes the first cluster 104a, as well as a “private message” to member link 170. Accessing the link 170 allows the visitor to send a private message to the member shown. This allows members to send and receive private messages between each other. The messaging will be managed in each user's private account page such as page 2100l. This will consist of a typical in/out box for messages. Members can also message other users via page 2100l by typing in the name of the other user.

Much of the above disclosure has been directed to regular members and officials as users of website 100. Groups are a third type of member for the website as contrasted with regular members or officials. Groups may have some functions and permissions of the other type of users, as well as different functions and permissions. Overall, Groups can act more like a regular member, but can speak as one on behalf of several members.

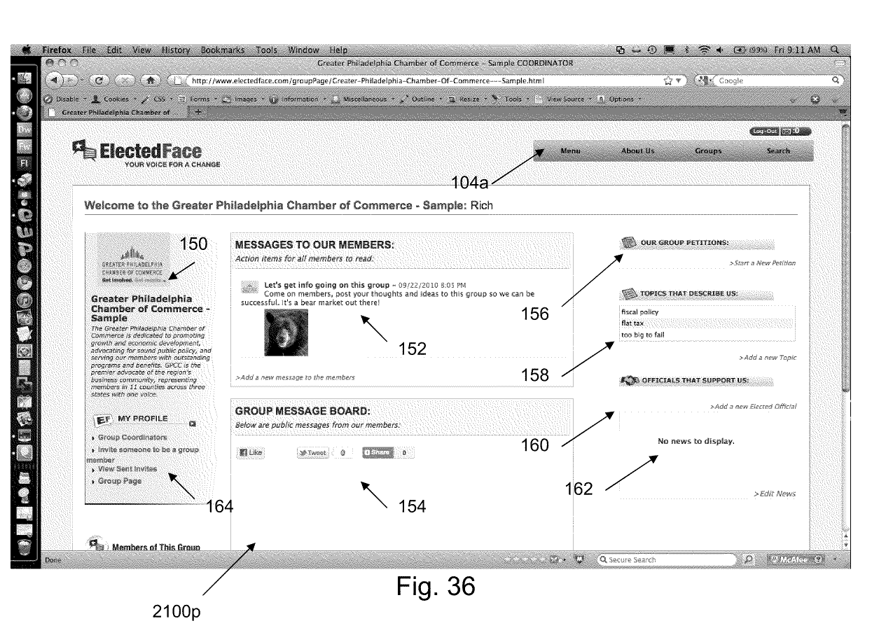

Referring now also to FIG. 36, there is shown an embodiment of a page 2100p of website 100. Page 2100p may be well suited for being presented when a user has selected to view information about a specific Group, which may be accessed for example via a link within the first cluster 104a or second cluster 104b. Page 2100p may generally include navigation and/or content elements, including first cluster 104a. Content 106 may include: the name and description 150 of the Group; messages 152 from the Group leadership to its members; a Group message board 154; a list 156 of group sponsored petitions; a list 158 of Group descriptive topics; a list 160 of officials that have indicated a support for the Group (which in an embodiment can only be provided by an approving official and/or an authorized representative to prevent fraudulent endorsements); a news feed 162 (such as an RSS feed); and a list 164 of Group members. Additional navigation elements 104 may provide links to Group coordinates, send invitations, view sent invitations, and a Group page. A Group essentially resides on its own page 2100p much as individual members have, which serves as the main communication area for the Group.

Groups preferably will reflect political topics. Such topics can appear as a new tab in the site's main navigation, with the individual topics as a drop-down menu. Members and non-members can have the ability to view Groups from any page that supports a link thereto, such as found in cluster 104a.

Each Group page 2100p preferably has an assigned member who serves as a Group Coordinator or Leader. The coordinator preferably can: make postings to an Elected Official's page on behalf of the group; create and post messages to the Group's Profile page; start petitions on behalf of the Group; remove members from the Group; and/or create/edit the Group's description and/or other content 106.

Preferably, members of the website 100 will have the option to join groups at will with no restrictions; non-members preferably can view the group page 2100p, but preferably cannot join absent membership to the website 100. To sign up for a Group, the user preferably must be a member of the website 100, and membership in a Group is preferably automatic upon signing up. However, the invention is not so limited, and membership could be reviewed by the Group coordinator(s) before approval. Being that the system already has the member's information, no other details are preferably needed from a member. A reminder or welcome message can be sent to the member after they sign up, as well as a link to the Group's page. The system can add the joined Group to the member's profile page 2100f. Members can be a member of more than one Group.

Preferably, members can start their own groups through a sign up page. Once completed, the Group will show up dynamically in the Group drop-down menu. The person who starts the new Group will be the Group Coordinator, and have full control over the Group. The Group leader may need to sign into the system with a new password that gives them access to the Group's profile page 2100p, as well as its administrative functions (sending messages, posting to officials, etc.).

Group pages preferably have format and content that follows a particular template, such that one group's page looks the same as any other page. In the alternative, some customization tools can be provided, akin to the manner in which individuals may design web pages by mixing and matching from different templates.

In some cases, it may be preferably for the website administrator to manually register the Group. This allows a degree of personalization and customization by the administrator in developing a Group's profile page as opposed to the generic page set up directly by the individual members. This option may be preferable for an established organization, such as a union, trade organization or political party.

Whoever has authority to speak on behalf of the Group preferably signs in under a different profile than their individual membership (if they have one). This ensures that the user's comments and actions are properly attributed to the user as an individual or in the representative capacity as appropriate for the user's intent.

Similar to FIGS. 13-20, FIGS. 37-45 are directed to administrative control over the website 100. To obtain access, a system administrator initially logs into the system using a web page consistent with page 100k of FIG. 13.

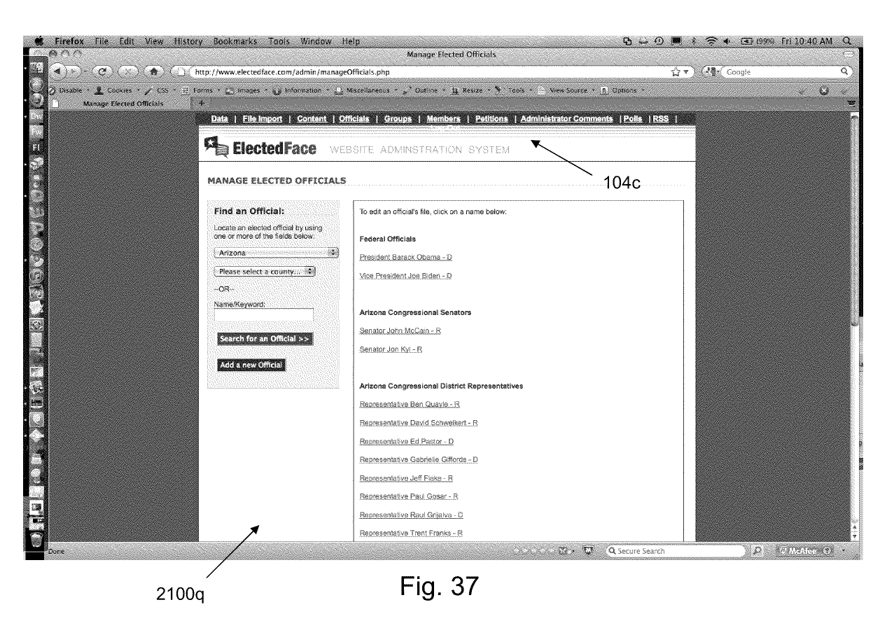

Referring now also to FIG. 37, there is shown an embodiment of a page 2100q corresponding to website 100. Navigation elements 104 include an administrator specific third cluster 104c that includes links to data management, file import, content management, official management, group management, member management, petition management, administrator comments, poll/survey management, and news feed (RSS management). The specific content 106 of page 2100q is directed to official management, and provides a list of links to officials, search tools for locating a link to an official, and/or adding an official.

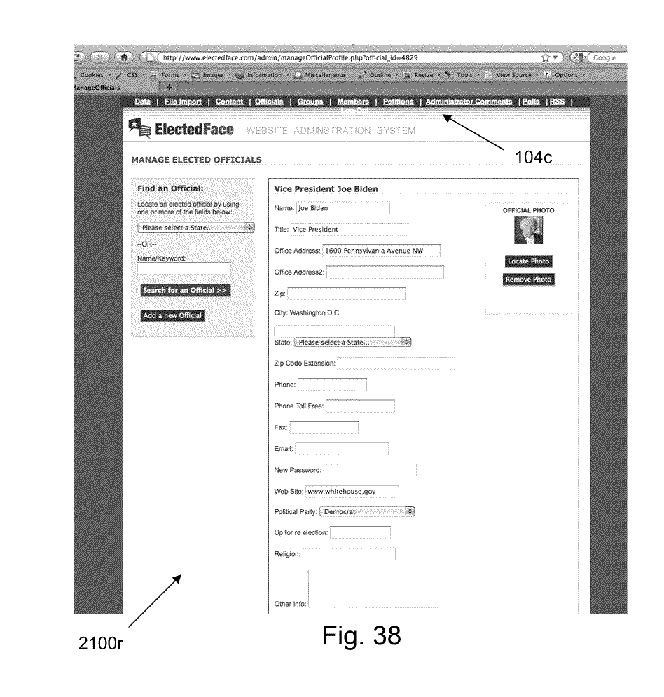

Referring now also to FIG. 38, there is shown an embodiment of a page 2100r corresponding to website 100. Page 2100r may be well suited for being presented when an administrative user of website 100 selects a candidate/official to check, change or delete information about. Navigation elements 104 allow administrative users search tools for locating a link to an official, and/or adding an official. Additionally, page 2100r allows an administrative user to enter information to be presented (e.g., as content 106) regarding officials, such as name, title, address, phone, fax, email, website, political party, religion, and/or other types of information. Additionally, page 2100r allows a user to change such a politician's password (if a member) to log into the system.

Entered information may be stored in one or more databases included in or accessible to devices 20 (FIG. 1), for use in populating website 100 in a conventional manner.

As shown in page 100m of FIG. 15, page 2100r of FIG. 28 may display recent comments of other users regarding the subject politician. Posts, when entered, may similarly be stored in one or more databases included in or accessible to devices 20 (FIG. 1), for use in populating website 100 in a conventional manner.

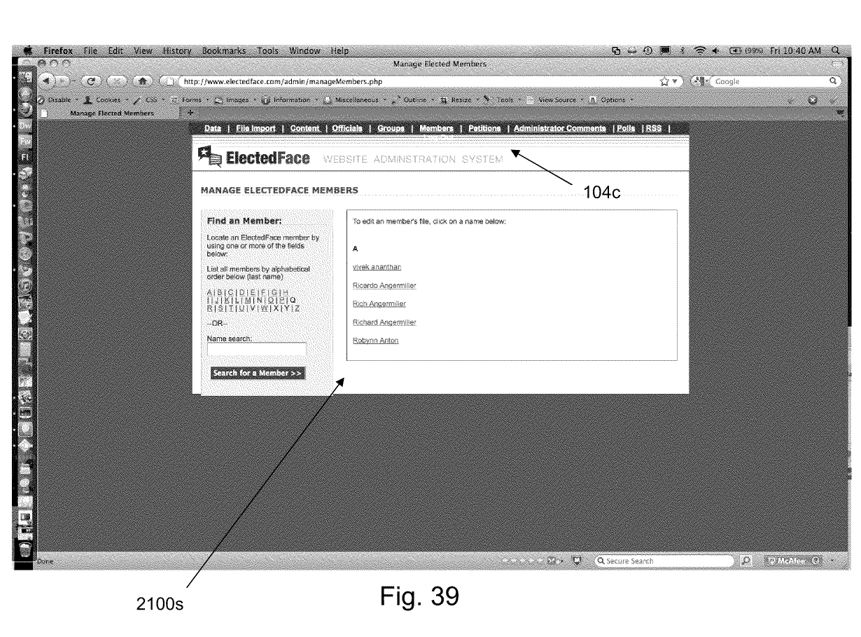

Referring now also to FIG. 39, there is shown an embodiment of a page 2100s corresponding to website 100. Page 2100s may be well suited for presenting when an administrative user of website 100 desires to find or search for a registered user via the “member” link in cluster 104c. For example, registered members may be listed in a predefined order, such as alphabetically, and/or be searchable.

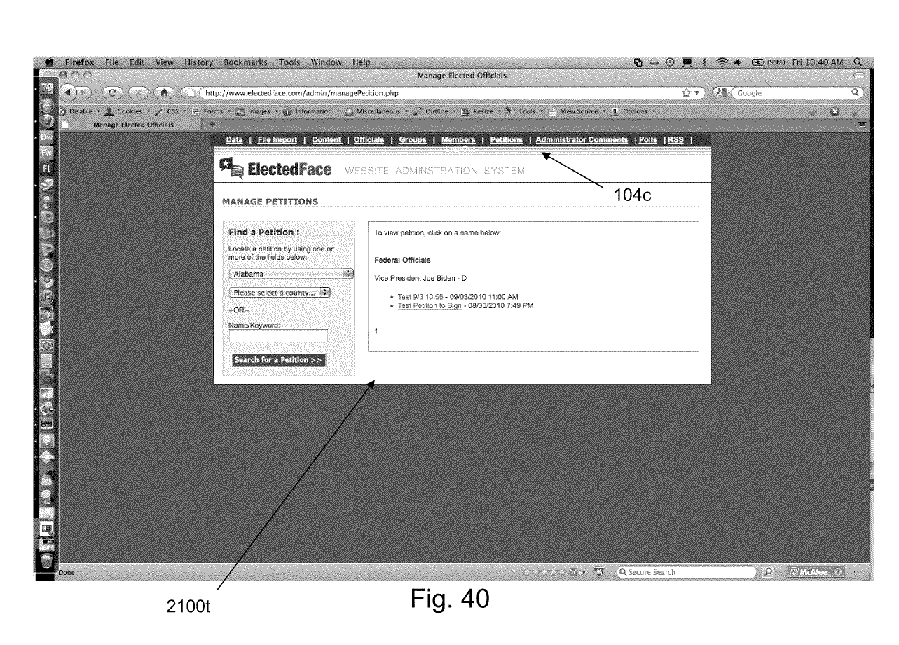

Referring now also to FIG. 40, there is shown an embodiment of a page 2100t corresponding to website 100. Page 2100t allows an administrative user to search for and find petitions regarding politicians and political areas, such as nation, state, county and municipality. An administrator can reach page 2100t via the “petitions” link in cluster 104c.

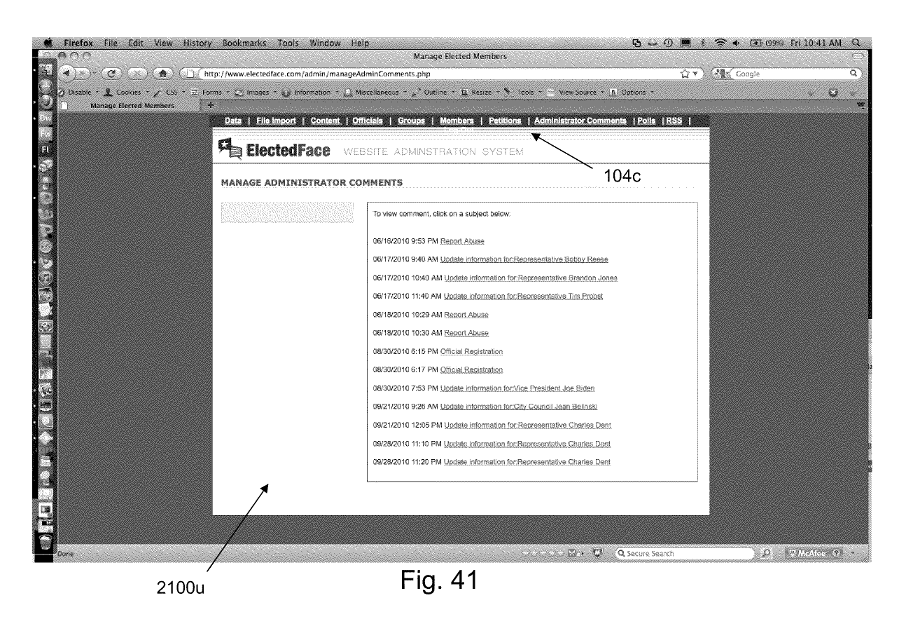

Referring now also to FIG. 41, there is shown an embodiment of a page 2100u corresponding to website 100. Page 2100u allows an administrative user to manage communications, such as abuse reports, associated with website 100. Upon requesting page 2100u such as by activating an “Administrative Comments” link embedded in cluster 104c, such a database may be used to populate page 2100u. An administrative user may use the administrative pages discussed herein to investigate and take appropriate action regarding such reports, such as ignoring the report, deleting a post and/or warning or deleting a registered user. Other changes to the system databases may also be logged, for example.

By way of non-limiting further explanation, if a user of website 100 believes the system is being abused, such as via what he/she deems to be inappropriate posts or petitions, they may opt to report system abuse, such as by activating a “Report Abuse” link embedded in an appropriate page. An entry in a database part of or accessible to devices 20 may be generated responsively to such a link activation.

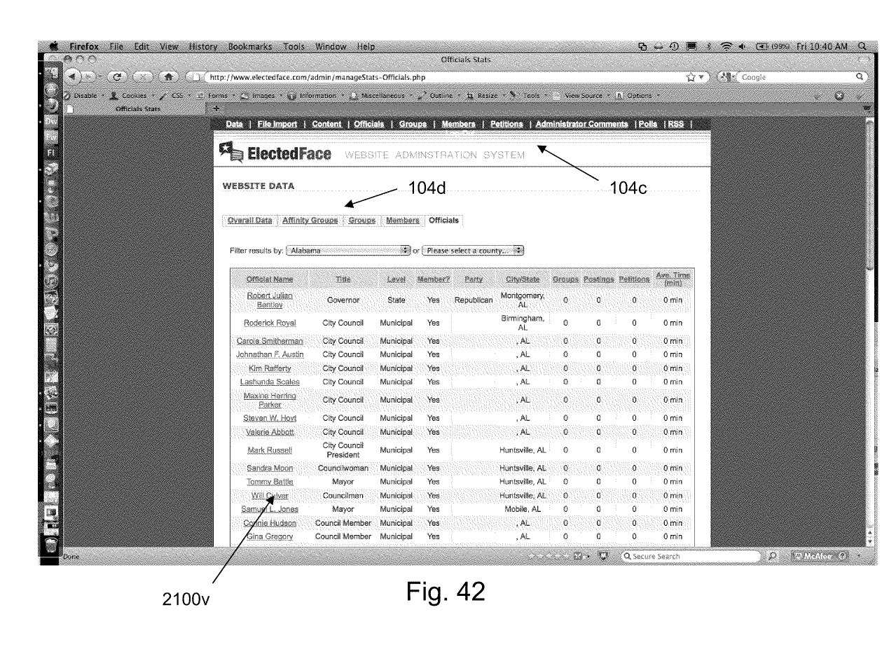

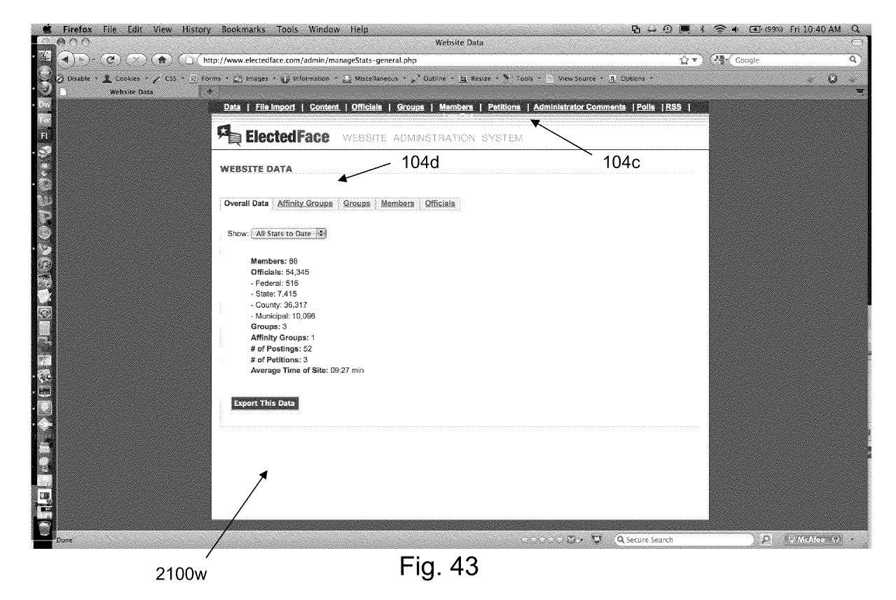

Referring now also to FIGS. 42 and 43, there are shown embodiments of pages 2100v and 2100w corresponding to website 100. Page 2100v allows an administrative user to display website data in various collections, such as overall data, affinity groups (a specialized Group for which financial arrangements can be made to based upon use of the website by the Group members), Groups, Members and Officials. FIG. 42 shows a display of the Officials, and FIG. 43 displays overall website data. An administrator may reach page 2100v and 2100w via the “data” link in cluster 104c, with further sub-selection of website data topic links in a cluster 104d.

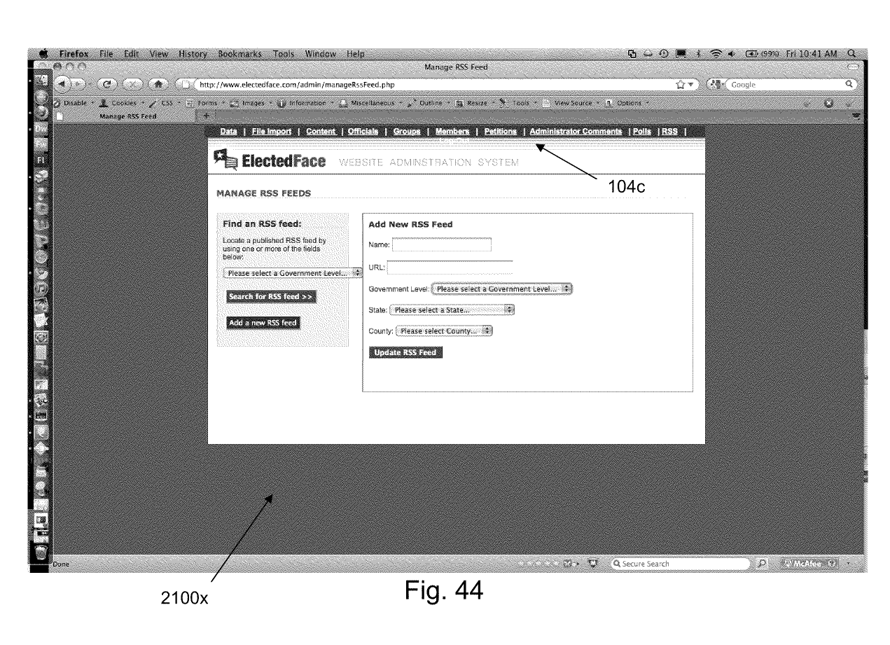

Referring now also to FIG. 44, there is shown an embodiment of a page 2100x corresponding to website 100. Page 2100x allows for an administrative user to manage RSS news feeds, which will appear on relevant pages as discussed above. An administrator may reach page 2100x via the “RSS” link in cluster 104c.

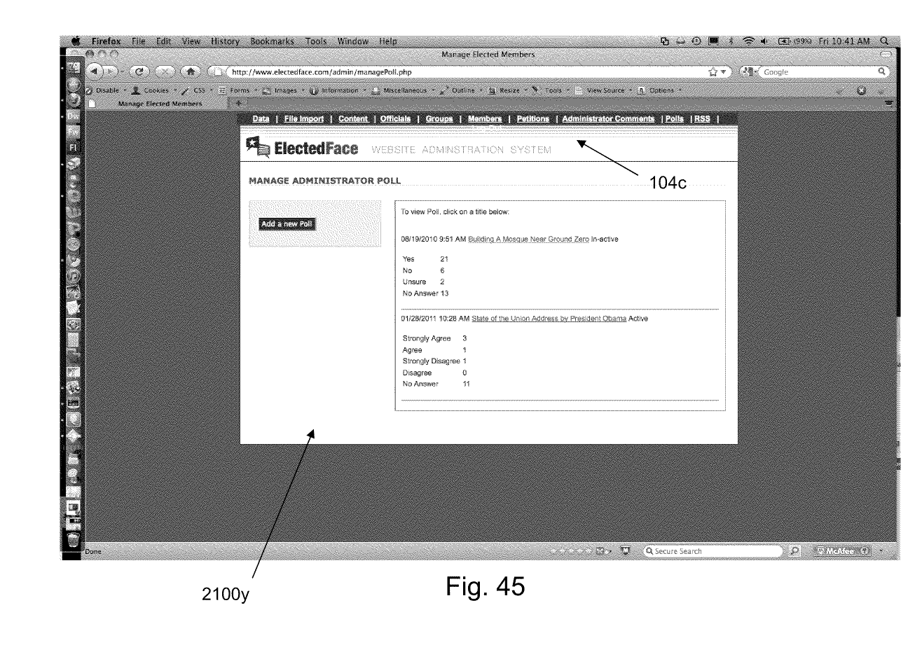

Referring now also to FIG. 45, there is shown an embodiment of a page 2100y corresponding to website 100. Page 2100y allows an administrative user to manage petitions. An administrator may reach page 2100y via the “petitions” link in cluster 104c.

The system can also organize official information to identify upcoming election races with announced candidates. For example, a user may be able to access a page for all of the political races for a geographic location that the user identifies; if the user is a member, this could be an option presented on the member's profile page 2100f. Options can be provided to narrow the search by year, type (federal, state, etc.), affiliation (Democrat, Republican, etc.), etc. The search results would identify the candidates, which would double as links to those candidates' pages 2100g. Similarly, an official's page can provide links to the official's opponents, by listing the opponents with links and/or a general link to a page that would populate with all opponents.

Although the invention has been described with respect to government officials, the invention is not so limited. Not all jurisdictions in the world have completely elected governments, but may be a royalty/democratic hybrid. Private organizations, such as unions, may also have some elected and non-elected personal. The embodiments herein can be used for any such environment.

The various navigation elements 104, content 106, and format thereof for the specific disclosed web pages are exemplary only. Any presentation that provides the desired functionality is within the scope and spirit of the invention.

It will be apparent to those skilled in the art that modifications and variations may be made in the systems and methods of the invention without departing from the spirit or scope of the invention. It is intended that the invention cover the modifications and variations of this invention provided they come within the scope of the appended claims and their equivalents.

1. A method comprising:
storing, at a server operatively connected to a communication network, information associated with at least one official, wherein the information defines a constituency group for each elected official and for each candidate for election for which information is stored on the server;
qualifying a user for one or more of the constituency groups when the user accesses the server through a computing device, the qualifying comprising determining which of the at least one official represents the user based on a voting based geographic parameter of the user; and
providing the user access through a common portal to information associated with the at least one official for which the user is a qualified member of the respective constituency group.
